(19) United States
(12) Patent Application Publication
(10) Pub. No.: US 2009/0083261 A1
(43) Pub. Date: Mar. 26, 2009

(54) INFORMATION DISPLAY APPARATUS, INFORMATION DISPLAY METHOD, AND COMPUTER PROGRAM PRODUCT

(75) Inventors: Shinichi Nagano, Kanagawa (JP); Masumi Inaba, Kanagawa (JP); Kenta Cho, Tokyo (JP); Yumiko Shimogori, Kanagawa (JP); Takahiro Kawamura, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/212,740

(22) Filed: Sep. 18, 2008

(30) Foreign Application Priority Data
Sep. 26, 2007 (JP) 2007-249017

(51) Int. Cl. G06F 7/06; G06F 17/30

(52) U.S. Cl. 707/5; 707/E17.014

(57) ABSTRACT

A keyword expressing a search target and an instance of information associated with the keyword are extracted from a character string included in a web document acquired for the keyword, based on a topic ontology, a relationship between the instances is visualized in a first topic graph expressed by a size of a topic node and a length of a topic link, and a reference relationship between web documents, which are an information source, is visualized in a blog graph expressed by a blog node and a blog link.

### CROSS-REFERENCE TO RELATED APPLICATIONS

This application is based upon and claims the benefit of priority from the prior Japanese Patent Application No. 2007-249017, filed on Sep. 26, 2007; the entire contents of which are incorporated herein by reference.

### BACKGROUND OF THE INVENTION

1. Field of the Invention

The present invention relates to an information display apparatus capable of displaying information associated with a specific keyword, an information display method, and a computer program product.

2. Description of the Related Art

Recently, there have been a growing number of consumers who purchase items based on evaluations and word-of-mouth reputations on the Internet. Particularly, consumer generated media (CGM) such as blog (Weblog) and social network service (SNS) are frequently used, by which users express analysis and opinions based on their own point of view, and therefore these media become a useful information source to know the evaluations with respect to a specific target. Thus, marketing researches aimed at the CGM have become important, and it has been desired to visualize relationships between pieces of information related to an object such as consumer goods. Particularly, it is desired to compare a specific item to be analyzed with an item related to the item or a currently popular item, and to visualize the relationship such as popularity of the relevant item.

With respect to such a demand, there has been proposed a technique for calculating a degree of relevance between websites or a degree of relevance between specific categories to display a result thereof (for example, see JP-A 2005-251157 (KOKAI)), as well as a technique for expressing a map from a set of information items by using a self-organizing map, to search for and display information with respect to the information item selected by the user based on the map (for example, see JP-A 2004-178605 (KOKAI)).

However, according to the technique disclosed in JP-A 2005-251157 (KOKAI), relevant information related to the information of a search object is only displayed from a standpoint of the degree of relevance between websites or the degree of relevance between categories of the website. Therefore, the relationship between an object such as an item as the search object and items associated with the item cannot be visualized. In addition, according to the technique disclosed in JP-A 2004-178605 (KOKAI), it is highly likely that an unnecessary term is extracted at the time of searching for information related to the object to be searched, and this causes a problem of increasing noise.

### SUMMARY OF THE INVENTION

According to one aspect of the present invention, an information display apparatus includes a display unit, a first accepting unit that accepts a keyword to be searched; an acquiring unit that acquires one or a plurality of web documents associated with the keyword from a network; a dividing unit that divides a character string included in each of the web document into one or a plurality of words; a first storage unit that stores an ontology in which an instance expressing each of the words is defined in association with a class to which the instance belongs, and a relation between the instances is defined by a distance between the classes; an instance extracting unit that extracts an instance matching each of the words divided by the dividing unit from the ontology; a second storage unit that stores the web documents, each extracted instance in association with the web document including the word matching the instance, and stores a reference relationship indicating a connection between the web documents; a first display-condition determining unit that determines a size of a topic node at a time of displaying each instance stored in the second storage unit as a topic node according to number of web documents associated with each instance, and determines a length of a topic link connecting a topic node of the instance expressing a word of the keyword to a topic node of an instance other than the instance according to a distance between classes to which each instance defined in the ontology belongs; a second display-condition determining unit that determines a connection of web links, which connects the web nodes, at a time of displaying each web document stored in the second storage unit as a web node, based on the reference relationship of the web documents; a first display control unit that displays a first graph in which a relationship between instances stored in the second storage unit is expressed by the topic node and the topic link, in a first display area of the display unit, based on a size of the topic node and the length of the topic link determined by the first display-condition determining unit; and a second display control unit that displays a second graph in which the relationship between web documents stored in the second storage unit is expressed by the web node and the web link, in a second display area of the display unit, based on the connection of the web links determined by the second display-condition determining unit.

According to another aspect of the present invention, an information display method executed by an information display apparatus including a display unit, includes accepting a keyword to be searched; acquiring one or a plurality of web documents associated with the keyword from a network; dividing a character string included in each of the web document into one or a plurality of words; extracting an instance matching each of the words divided at the dividing from an ontology in which the instance expressing each of the words is defined in association with a class to which the instance belongs, and a relation between the instances is defined by a distance between the classes; storing including storing each instance extracted from the ontology in association with the web document including the word matching the instance, and storing a reference relationship indicating a connection between the web documents; first determining of determining a size of a topic node at a time of displaying each instance stored at the storing as a topic node according to number of web documents associated with each instance; second determining of determining a length of a topic link connecting a topic node of the instance expressing a word of the keyword to a topic node of an instance other than the instance according to a distance between classes to which each instance defined in the ontology belongs; third determining of determining a connection of web links, which connects the web nodes, at a time of displaying each web document stored at the storing as a web node, based on the reference relationship of the web documents; first displaying of displaying a first graph in which a relationship between the instances stored at the storing is expressed by the topic node and the topic link, in a first display area of the display unit, based on a size of the topic node and the length of the topic link; and second displaying of displaying a second graph in which the relationship between the web documents stored at the storing is expressed by the web node and the web link, in a second display area of the display unit, based on the connection of the web links.

According to still another aspect of the present invention, a computer program product having a computer readable medium including programmed instructions executable by a computer provided with a display unit, wherein the instructions, when executed by the computer, cause the computer to perform accepting a keyword to be searched; acquiring one or a plurality of web documents associated with the keyword from a network; dividing a character string included in each of the web document into one or a plurality of words; extracting an instance matching each of the words divided at the dividing from an ontology in which the instance expressing each of the words is defined in association with a class to which the instance belongs, and a relation between the instances is defined by a distance between the classes; storing including storing each instance extracted at the extracting in association with the web document including the word matching the instance, and storing a reference relationship indicating a connection between the web documents; first determining of determining a size of a topic node at a time of displaying each instance stored at the storing as a topic node according to number of web documents associated with each instance; second determining of determining a length of a topic link connecting a topic node of the instance expressing a word of the keyword to a topic node of an instance other than the instance according to a distance between classes to which each instance defined in the ontology belongs; third determining of determining a connection of web links, which connects the web nodes, at a time of displaying each web document stored at the storing as a web node, based on the reference relationship of the web documents; first displaying of displaying a first graph in which a relationship between instances stored at the storing is expressed by the topic node and the topic link, in a first display area of the display unit, based on a size of the topic node and the length of the topic link; and second displaying of displaying a second graph in which the relationship between web documents stored at the storing is expressed by the web node and the web link, in a second display area of the display unit, based on the connection of the web links.

### BRIEF DESCRIPTION OF THE DRAWINGS

FIG. 1 depicts a configuration of an information display system;

FIG. 2 depicts a hardware configuration of a relevant-information extracting server;

FIG. 3 is a schematic diagram of one example of a topic ontology;

FIG. 4 depicts a functional configuration of a relevant-information extracting server according to a first embodiment of the present invention;

FIG. 5 is a flowchart of a relevant-information extracting process procedure;

FIG. 6 is a schematic diagram of one example of processing result information;

FIG. 7 is one example of instance display data;

FIG. 8 is a flowchart of an instance-display-data generating process procedure;

FIG. 9 is one example of class display data;

FIG. 10 is a flowchart of a class-display-data generating process procedure;

FIG. 11 is one example of blog-graph display data;

FIG. 12 is a flowchart of a blog-graph display-data generating process procedure;

FIG. 13 depicts a hardware configuration of a client terminal according to the first embodiment;

FIG. 14 depicts a functional configuration of the client terminal;

FIG. 15 is one example of display data displayed in a display area;

FIG. 16 is a flowchart of a relevant-information display process procedure;

FIG. 17 is a flowchart of a display-data generating process procedure;

FIG. 18 is a flowchart of a display-data update process procedure;

FIG. 19 is one example of display data displayed in the display area;

FIG. 20 is another example of display data displayed in the display area;

FIG. 21 depicts another mode of the functional configuration of the relevant-information extracting server according to the first embodiment;

FIG. 22 depicts another mode of the functional configuration of the client terminal according to the first embodiment;

FIG. 23 depicts a functional configuration of a client terminal according to a second embodiment of the present invention;

FIG. 24 depicts a functional configuration of a relevant-information extracting server according to the second embodiment;

FIG. 25 is a flowchart of a node-detail-information generating process procedure;

FIG. 26 is one example of node detail information;

FIG. 27 is a flowchart of a node-detail-information display process procedure;

FIG. 28 is one example of the node detail information displayed in the display area;

FIG. 29 is another example of the node detail information displayed in the display area;

FIG. 30 is still another example of the node detail information displayed in the display area;

FIG. 31 is still another example of the node detail information displayed in the display area;

FIG. 32 depicts a functional configuration of a client terminal according to a third embodiment of the present invention; and

FIG. 33 depicts a functional configuration of a relevant-information extracting server according to the third embodiment.

### DETAILED DESCRIPTION OF THE INVENTION

Exemplary embodiments of an information display apparatus, an information display method, and a program according to the present invention will be explained below in detail with reference to the accompanying drawings.

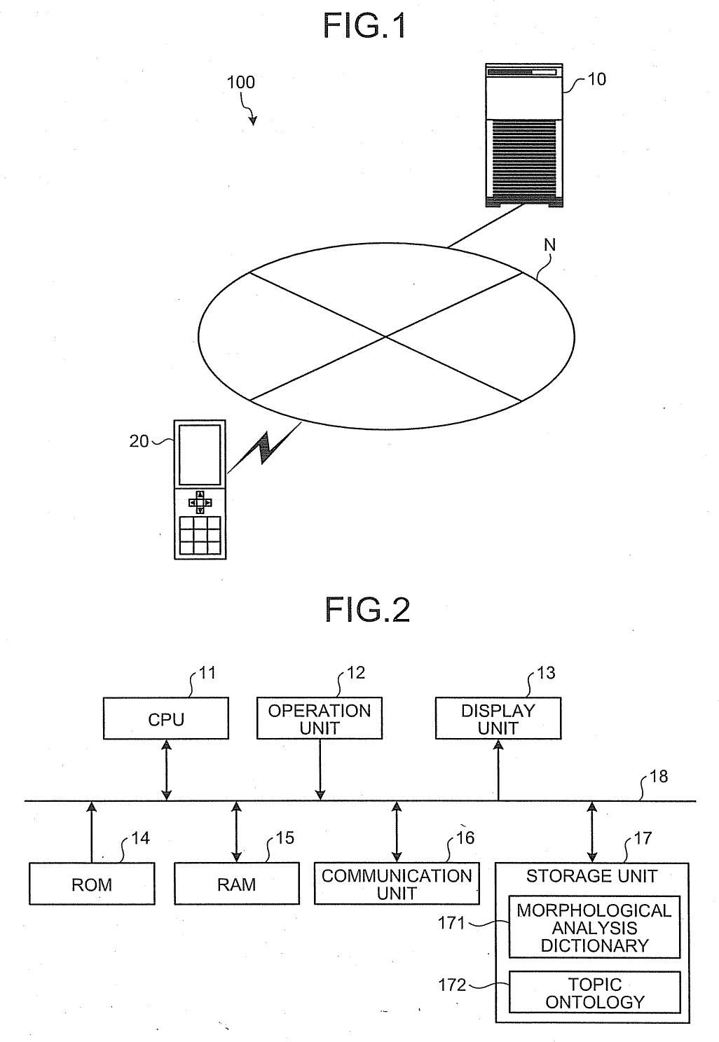

FIG. 1 is a block diagram of a configuration of an information display system 100 according to a first embodiment of the present invention. As shown in FIG. 1, the information display system 100 includes a relevant-information extracting server 10 and a client terminal 20, and the respective devices are communicably connected with each other via a network N.

The network N is a communication network such as the Internet, and a website (not shown) such as a blog site and other server devices such as a search engine are communicably connected to the relevant-information extracting server 10 and the client terminal 20. The number of the relevant-information extracting servers 10 and the client terminals 20 to be connected to the network N is not particularly limited.

The relevant-information extracting server 10 generates display data for visually displaying a relationship between a word (keyword) expressing an object to be searched for transmitted from the client terminal 20 and relevant object (hereinafter, “association topic”) relevant to the keyword according to the keyword. The relevant-information extracting server 10 is explained below in detail.

FIG. 2 is a block diagram of a hardware configuration of the relevant-information extracting server 10. As shown in FIG. 2, the relevant information extracting server 10 includes a central processing unit (CPU) 11, an operation unit 12, a display unit 13, a read only memory (ROM) 14, a random access memory (RAM) 15, a communication unit 16, and a storage unit 17, and the respective units are connected with each other via a bus 18. Relevant-information extracting servers 30, 60, and 80 described later have the same hardware configuration.

The CPU 11 uses a predetermined area of the RAM 15 as a work area to execute various processing in cooperation with various control programs prestored in the ROM 14 or the storage unit 17, thereby generally controlling the operation of the respective units constituting the relevant-information extracting server 10.

Further, the CPU 11 realizes functions of respective functional units described later in cooperation with a predetermined program prestored in the ROM 14 or the storage unit 17. The operation of the respective functional units will be described later.

The operation unit 12 includes various input keys, and receives information input from a user as an instruction signal to output the instruction signal to the CPU 11.

The display unit 13 includes a display device such as a liquid crystal display (LCD), and displays various pieces of information based on a display signal from the CPU 11. The display unit 13 can constitute a touch panel integrally with the operation unit 12.

The ROM 14 unrewritably stores programs and various pieces of setting information involved with the control of the relevant-information extracting server 10.

The RAM 15 is a storage device such as a synchronous dynamic RAM (SDRAM), and functions as a work area of the CPU 11 to play a role as a buffer or the like.

The communication unit 16 is an interface that communicates with external equipment via the network N. The communication unit 16 outputs various pieces of information (for example, a search request described later) transmitted from the external equipment to the CPU 11, and transmits various pieces of information (for example, display data described later) output from the CPU 11 to the external equipment.

The storage unit 17 includes a magnetically or optically recordable storage medium, and rewritably stores programs and various pieces of setting information involved with the control of the relevant-information extracting server 10. The storage unit 17 pre-stores a morphological analysis dictionary 171 for morphological analysis, and a topic ontology 172 that defines an instance respectively expressing a plurality of words (trade names) in association with a class to which the instance belongs, and also defines association between the instances according to a distance between the classes.

The morphological analysis dictionary 171 is dictionary data used at the time of morphological analysis processing performed by a morphological analysis unit 1122 described later, and a grammar rule defining a grammar of the language to be used and word groups to which information such as a part of speech is added are registered therein beforehand.

The topic ontology 172 is tree-structure data configured by a data model using an ontology technique. In the “ontology” here, an object world is modeled by a knowledge representation language from a specific point of view, and concepts held by words are systematically arranged. Conceptually, two types of concepts, that is, class and instance are mainly used. Intuitively, the class expresses a classification name of the concept and the instance expresses an example of the concept.

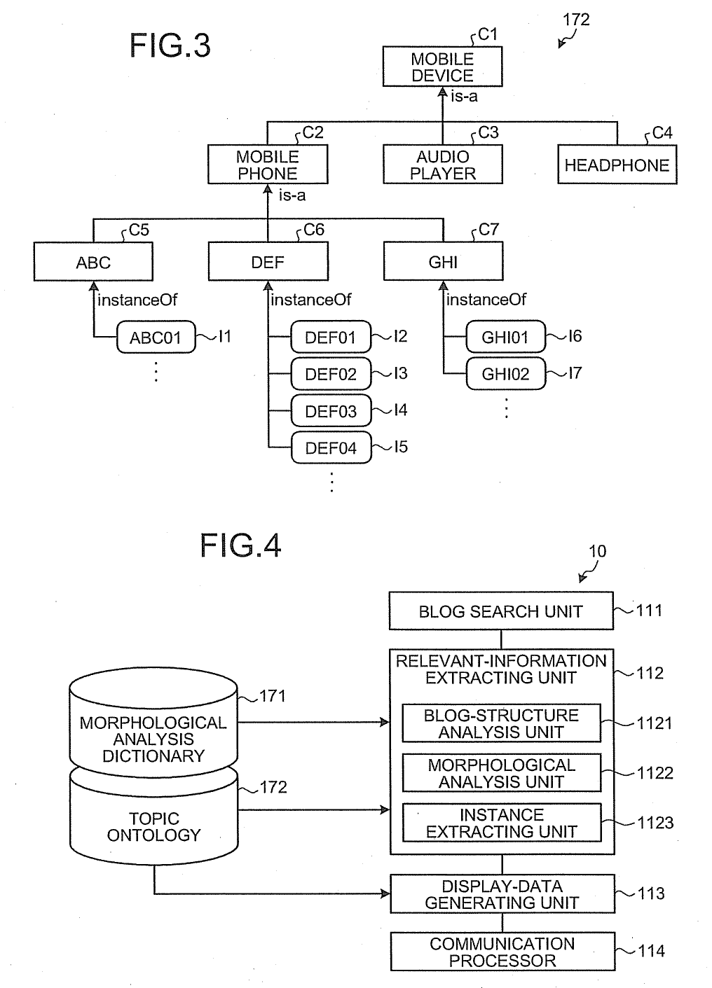

FIG. 3 is a schematic diagram of one example of the topic ontology 172. In the topic ontology 172, the target of the ontology is limited to commodities, and classification is performed based on the type of the commodity, a manufacturer's name, and the like.

The topic ontology 172 includes seven classes C1 to C7 and seven instances I1 to I7, and the class expresses a genre name and the instance expresses a specific trade name. In FIG. 3, seven instances I1 to I7 respectively express a terminal name of a mobile phone, and are defined under classes C5 to C7 expressing a carrier of the mobile phone. Classes C5 to C7 are defined under class C2 of a broader concept expressing the mobile phone itself. A mode of the topic ontology 172 is not limited to an example shown in FIG. 3, and the topic ontology 172 created for objects other than the commodity can be prestored.

FIG. 4 is a block diagram of a functional configuration of the relevant-information extracting server 10. As shown in FIG. 4, the relevant-information extracting server 10 includes a blog search unit 111, a relevant-information extracting unit 112, a display-data generating unit 113, and a communication processor 114.

Upon reception of a search request transmitted from the client terminal 20 via the communication unit 16 under control of the communication processor 114, the blog search unit 111 searches a blog site connected to the network N for a web document including a keyword included in the search request, to obtain a corresponding web document. The blog search unit 111 connects to the blog site with a uniform resource locator (URL) instructed from a blog-structure analysis unit 1121 described later, to obtain the web document from the blog site.

The web document acquired by the blog search unit 111 can be only a part of an article including the keyword, or can be the entire web document including the article. The blog search unit 111 temporarily stores the acquired web document in the RAM 15 or the storage unit 17 in association with the URL or a site name relating to the web document and identification information such as update date and time. Hereinafter, a set of the web document and the identification information is referred to as a “blog”. The blog can be searched by transmitting a keyword to the search engine installed in an external server device (not shown) to obtain a search result by the search engine, or can be searched by the relevant-information extracting server 10 itself by including a search engine in the relevant-information extracting server 10 separately.

The relevant-information extracting unit 112 includes, as shown in FIG. 4, the blog-structure analysis unit 1121, the morphological analysis unit 1122, and an instance extracting unit 1123.

The blog-structure analysis unit 1121 analyzes a data structure of the respective blogs acquired by the blog search unit 111, extracts a URL of other blog in a trackback relationship with the blog (hereinafter, “reference blog”) from a trackback column included in the respective blogs, and outputs the URL to the blog search unit 111, so that the blog search unit 111 acquires the reference blog.

It is assumed here that the blog acquired based on the keyword is used as a base point (route blog), so that the blog-structure analysis unit 1121 acquires up to a second link reference blog, that is, a first link reference blog having the trackback relationship with the route blog and the second link reference blog having the trackback relationship with the first link reference blog from the route blog. The acquisition range of the reference blog is not limited to the example, and an arbitrary setting is possible such that from the first link reference blog up to a third or fifth link reference blog are acquired.

The blog-structure analysis unit 1121 stores trackback information expressing the relationship between the blog, which is a trackback reference source (reference source blog), and the reference blog, in association with the respective blogs having the trackback relationship acquired by the blog search unit 111.

The blog-structure analysis unit 1121 calculates the number of comments described in a comment column of each blog acquired by the blog search unit 111, respectively, and stores the number of comments in association with the corresponding blog acquired by the blog search unit 111.

The morphological analysis unit 1122 performs a morphological analysis with respect to the respective blogs acquired by the blog search unit 111, using the morphological analysis dictionary 171, to divide a characteristic string included in the respective blogs into one or a plurality of words.

The instance extracting unit 1123 extracts a trade name (word) associated with the word of the keyword from the word group for each blog divided by the morphological analysis unit 1122 based on the respective classes and instances defined by the topic ontology 172, and stores the trade name in association with the corresponding blog. Hereinafter, the trade name extracted from the topic ontology 172 is referred to as an “association topic”. The trade name corresponding to the keyword is referred to as a “route topic”, and the route topic and the association topic are collectively referred to as a “topic”.

Specifically, the instance extracting unit 1123 searches the respective instances defined in the topic ontology 172 for the trade name identical to the keyword, to specify the trade name of the instance as the route topic. The instance extracting unit 1123 designates the trade name of the instance belonging to the class in a predetermined number of hops from the class as well as the name of other instances of the class to which the route topic belongs, as association topic candidates. The instance extracting unit 1123 extracts the trade name matching the word group constituting each blog, among trade names included in the association topic candidate, as the association topic, and holds the trade name in association with the blog including the identical word. The number of hops represents the number of classes to go through.

For example, to explain using the topic ontology 172 in FIG. 3, when the keyword is “DEF02” and the number of hops is “2”, the instance extracting unit 1123 specifies instance I3 (DEF02) belonging to class C6 (DEF) as the route topic. The instance extracting unit 1123 sets the trade names of instances within two hops from class C6, that is, the trade names of instances I2, I4, and I5 belonging to the own class C6, instance I1 belonging to class C5, and instances I6 and I7 belonging to class C7, as the association topic candidate, to compare the association topic candidate with a morpheme group (word group) constituting each blog. As the number of hops, a pre-set value can be used or a value instructed from outside can be used.

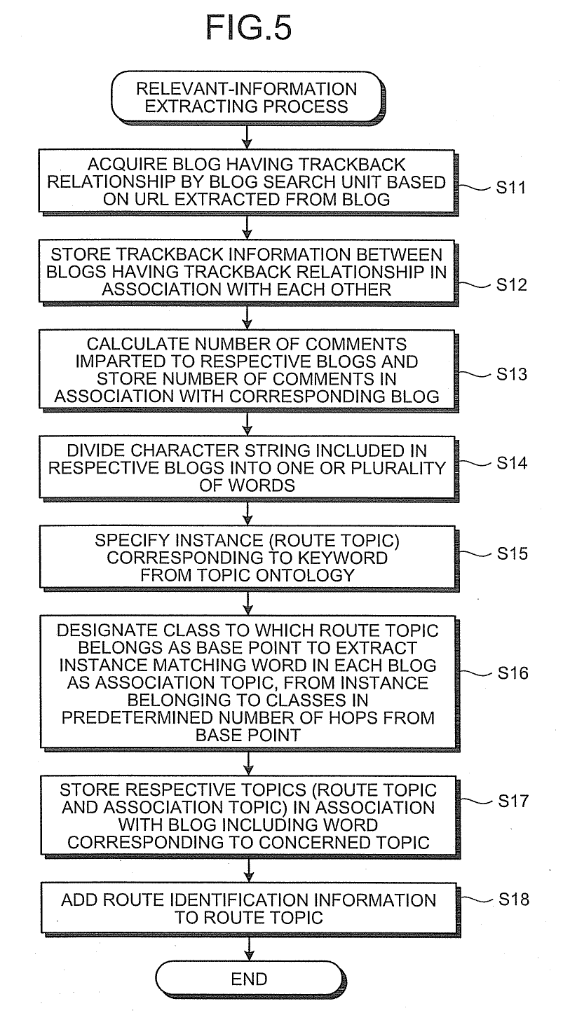

A relevant-information extracting process executed by the relevant-information extracting unit 112 is explained below with reference to FIG. 5. FIG. 5 is a flowchart of the relevant-information extracting process procedure.

First, the blog-structure analysis unit 1121 extracts the URL of the reference blog having the trackback relationship with the blog from the respective blogs acquired by the blog search unit 111 and outputs the URL to the blog search unit 111, thereby acquiring the reference blogs for the predetermined number of links by the blog search unit 111 (step S11).

The blog-structure analysis unit 1121 then stores the trackback information indicating that there is a trackback relationship with the reference blog, which forms a pair with the reference source blog to be trackbacked, in association with each other (step S12). The blog-structure analysis unit 1121 respectively calculates the number of comments imparted to the respective blogs and stores the number of comments in association with the corresponding blog (step S13).

Subsequently, the morphological analysis unit 1122 respectively performs the morphological analysis with respect to the respective blogs acquired by the blog search unit 111, using the morphological analysis dictionary 171, to divide the character string included in the respective blogs into one or a plurality of words (step S14).

The instance extracting unit 1123 then refers to the topic ontology 172 to specify the instance (route topic) corresponding to the keyword (step S15). The instance extracting unit 1123 designates the class to which the route topic belongs as the base point to extract an instance matching the word in each blog divided at step S14 as the association topic, from the instance belonging to the classes in the predetermined number of hops from this class (step S16).

Subsequently, the instance extracting unit 1123 stores the respective topics (the route topic and association topic) in association with the blog including the word corresponding to the topic (step S17), and adds route identification information, which indicates that the topic corresponds to the keyword, to the route topic (step S18), to finish the process.

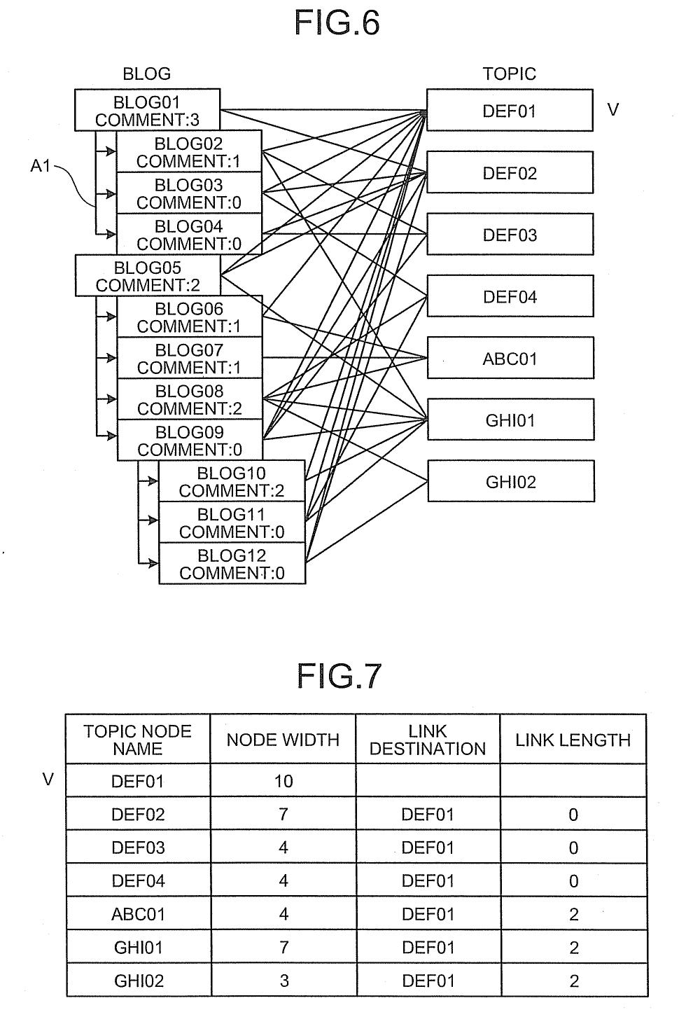

FIG. 6 is a schematic diagram of a state of the blog after the relevant-information extracting process. As shown in FIG. 6, the blogs (BLOG01 to BLOG12) acquired by the blog search unit 111 are held in the RAM 15 or the storage unit 17 in a state with trackback information A1 and the topic (DEF01 to 04, ABC01, GHI01 and GHI02) being associated with each other, as a result of the relevant-information extracting process performed by the relevant-information extracting unit 112. Hereinafter, the blog processed by the relevant-information extracting unit 112 is referred to as “processing result information”.

In FIG. 6, it is shown that the blog connected by the trackback information A1 has the trackback relationship, where the blog, which is a source of arrow, indicates the reference source blog to be trackbacked, and the blog, which is a point of arrow, indicates the reference blog. The numerical value in “COMMENT:” added to the respective blogs indicates the number of comments contributed to the respective blogs. The route identification information shown by “V” is added to the topic corresponding to the keyword of the topic group.

Returning to FIG. 2, the display-data generating unit 113 generates the display data for displaying the data on a display unit 23 of the client terminal 20 based on the processing result information held in the RAM 15 or the storage unit 17. The display data to be generated can be roughly divided into topic graph display data for displaying a topic graph and blog graph display data for displaying a blog graph.

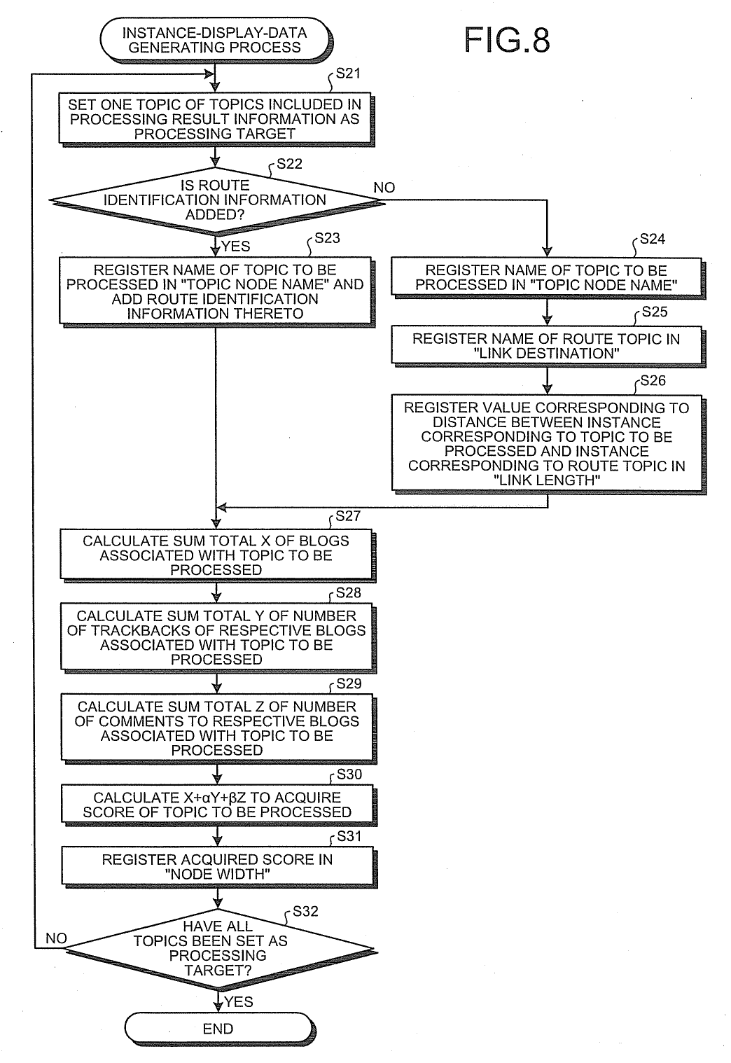

The topic graph expresses a relationship between the keyword instructed from the client terminal 20 and other pieces of information associated with the keyword in a network graph, based on the relationship between the instances or the classes defined in the topic ontology 172. The topic graph display data (instance display data) for displaying the topic graph based on the relationship between the instances is explained with reference to FIGS. 7 and 8.

FIG. 7 is one example of the instance display data generated by the display-data generating unit 113. As shown in FIG. 7, in the instance display data, “topic node name”, “node width”, “link destination”, and “link length” are registered in association with each other.

The “topic node name” is an item indicating a name at the time of displaying the respective topics included in the processing result information as a topic node TN, and names of the respective topics (trade names) are registered therein.

The “node width” is an item indicating a size at the time of displaying the topic node TN, and a value corresponding to a score for each topic calculated by weighting the number of trackbacks or the number of comments in each blog based on the number of articles in the blog in which each topic appears is registered therein. The node width indicates a degree at which the name of each topic is accepted, that is, a degree of attention or degree of interest. As the numerical value of the node width increases, the topic node TN is displayed in a larger size.

The “link destination” is an item indicating a connection between the route topic and the association topic. Specifically, the “link destination” instructs to connect the topic node TN of the name registered in the “topic node name” and the topic node TN of the name (route topic) registered in the “link destination” by a topic link TL described later.

The “link length” is an item indicating the length of the topic link TL, and a value derived based on a distance (the number of hops based on the class) between the corresponding instances defined in the topic ontology 172 is registered therein. As the numerical value of the link length increases, that is, as the distance between the instances increases, the topic link TL is displayed longer.

In the instance display data shown in FIG. 7, “V” added to topic node name “DEF01” is the route identification information indicating that it is the topic node corresponding to the route topic, and added thereto at the time of registration of the topic node name.

An instance-display-data generating process executed by the display-data generating unit 113 is explained with reference to FIG. 8. FIG. 8 is a flowchart of the instance-display-data generating process procedure.

First, the display-data generating unit 113 sets one topic of the topics included in the processing result information as a processing target by referring to the processing result information held in the RAM 15 or the storage unit 17 (step S21). The display-data generating unit 113 then determines whether the topic as the processing target is the route topic, based on whether the route identification information is added to the topic as the processing target (step S22).

When determining that the topic as the processing target is the route topic (YES at step S22), the display-data generating unit 113 registers the name of the topic (trade name) in “topic node name” in the instance display data and adds the route identification information indicating that it is the route topic thereto (step S23), to proceed to the processing at step S27.

On the other hand, at step S22, when determining that the topic to be processed is the association topic (NO at step S22), the display-data generating unit 113 registers the name of the topic in “topic node name” in the instance display data (step S24), and registers the name of the route topic in the “link destination” (step S25).

Subsequently, the display-data generating unit 113 refers to the topic ontology 172 to derive the distance between the instance corresponding to the topic to be processed and the instance corresponding to the route topic, based on the distance (the number of hops based on the class) between the both instances, and registers the value in the “link length” in the instance display data (step S26), to proceed to the processing at step S27.

At step S27, the display-data generating unit 113 refers to the processing result information to calculate the sum total X of the blogs associated with the topic to be processed (step S27). Subsequently, the display-data generating unit 113 refers to the processing result information to calculate the sum total Y of the number of trackbacks of the respective blogs associated with the topic to be processed (step S28), and calculates the sum total Z of the number of comments added to the respective blogs (step S29). The sum total Y of the number of trackbacks is calculated based on the trackback information associated with the respective blogs, and a pair of trackback information from the reference source blog to the reference blog is counted as 1.

Subsequently, the display-data generating unit 113 calculates X+αY+βZ to acquire the score of the topic to be processed (step S30). Here, “α” and “β” are proportional constants expressing a weight component, and an arbitrary value can be set. The relational expression for calculating the score is not limited thereto.

The display-data generating unit 113 registers the score acquired at step S30 in the “node width” in the instance display data (step S31).

The display-data generating unit 113 determines whether all the topics included in the processing result information have been set as the processing target. When determining that there is an unprocessed topic (NO at step S32), the display-data generating unit 113 returns to step S21 again, to set the unprocessed topic as the processing target.

On the other hand, at step S32, when determining that all the topics have been set as the processing target (YES at step S32), the display-data generating unit 113 finishes the process. The display-data generating unit 113 executes the process to generate the instance display data as shown in FIG. 7.

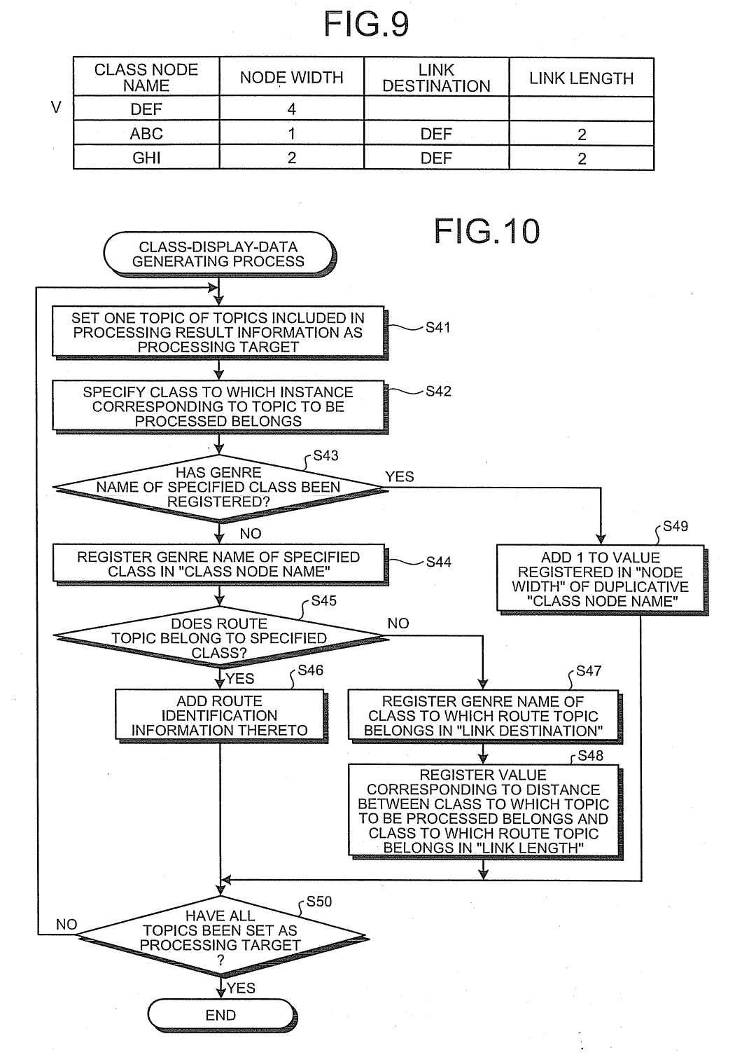

The topic graph display data (class display data) for displaying the topic graph based on the relationship between the classes is explained with reference to FIGS. 9 and 10.

FIG. 9 is one example of the class display data generated by the display-data generating unit 113. As shown in FIG. 9, in the class display data, “class node name”, “node width”, “link destination”, and “link length” are registered in association with each other.

The “class node name” is an item indicating a name at the time of displaying the respective classes, to which the respective topics included in the processing result information belong, as a class node CN, and names of the respective classes (genre names) are registered therein.

The “node width” is an item indicating a size at the time of displaying the class node CN, and a value corresponding to the number of topics belonging to the respective classes is registered therein. The node width indicates a degree at which the name of each topic is accepted, that is, a degree of attention or degree of interest is expressed in a unit of class of a broader concept. As the numerical value of the node width increases, the class node CN is displayed in a larger size.

The “link destination” is an item indicating a connection between the class (route class) to which the route topic belongs and another class. Specifically, the “link destination” instructs to connect the class node CN of the name (genre) registered in the “class node name” and the class node CN of the name registered in the “link destination” by a class link CL described later.

The “link length” is an item indicating the length of the class link CL, and a value derived based on a distance (the number of hops) between the corresponding instances defined in the topic ontology 172 is registered therein. As the numerical value of the link length increases, that is, as the distance between the classes increases, the class link CL is displayed longer.

In the class display data shown in FIG. 9, class node name “DEF” added with “V” is the route identification information indicating that it is the class node corresponding to the route class, and added thereto at the time of registration of the class node name.

A class-display-data generating process executed by the display-data generating unit 113 is explained below with reference to FIG. 10. FIG. 10 is a flowchart of the class-display-data generating process procedure.

First, the display-data generating unit 113 sets one topic of the topics included in the processing result information as a processing target by referring to the processing result information held in the RAM 15 or the storage unit 17 (step S41). The display-data generating unit 113 then refers to the topic ontology 172 to specify the class to which the instance corresponding to the topic to be processed belongs (step S42).

The display-data generating unit 113 then determines whether the genre name of the class specified at step S42 is registered in “class node name” in the class display data (step S43). When determining that the genre name is not registered in the “class node name” (NO at step S43), the display-data generating unit 113 registers the genre name of the class to be processed in the “class node name” in the class display data (step S44), and then determines whether the route topic belongs to the class (step S45).

At step S45, when determining that the route topic belongs to the class (YES at step S45), the display-data generating unit 113 adds the route identification information to the “class node name” thereto (step S46), to proceed to the processing at step S50.

Further, at step S45, when determining that the route topic does not belong to the class (NO at step S45), the display-data generating unit 113 registers the genre name of the class (route class) to which the route topic belongs in the “link destination” in the class display data (step S47).

Subsequently, the display-data generating unit 113 refers to the topic ontology 172 to derive the distance between the class to which the topic to be processed belongs and the class to which the route topic belongs, based on the distance (the number of hops based on the class) between the both instances, and registers the value in the “link length” in the class display data (step S48), to proceed to the processing at step S50.

On the other hand, at step S43, when determining that the genre name of the class specified at step S42 has been already registered in the “class node name” in the class display data (YES at step S43), the display-data generating unit 113 adds 1 to the value registered in the “node width” of the duplicative “class node name” (step S49), to proceed to the processing at step S50. It is assumed here that an initial value of the registered value in the “node width” is 0.

At step S50, the display-data generating unit 113 determines whether all the topics included in the processing result information have been set as the processing target. When determining that there is an unprocessed topic (NO at step S50), the display-data generating unit 113 returns to step S41 again, to set the unprocessed topic as the processing target.

On the other hand, at step S50, when determining that all the topics have been set as the processing target (YES at step S50), the display-data generating unit 113 finishes the process. The display-data generating unit 113 executes the process to generate the class display data as shown in FIG. 9.

The display-data generating unit 113 executes any one of the instance-display-data generating process or the class-display-data generating process according to the predetermined setting content or the instruction content instructed from the user, and handles the generated instance display data or class display data as the topic graph display data.

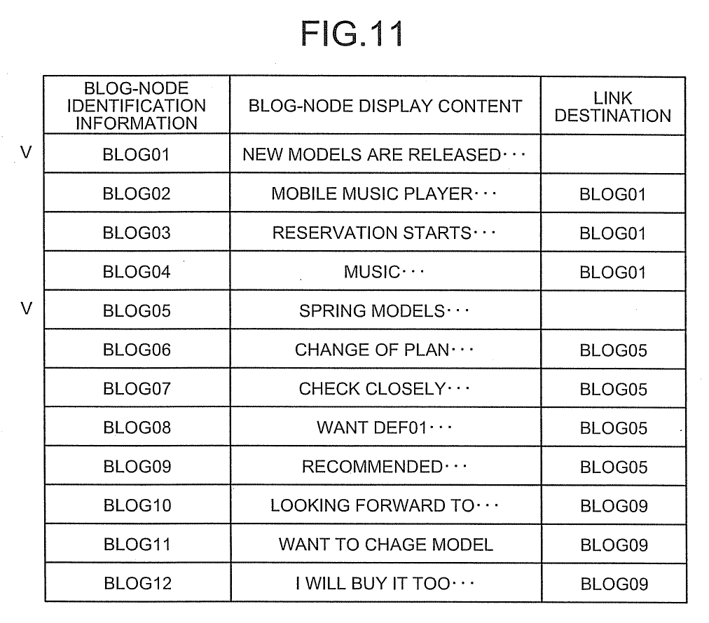

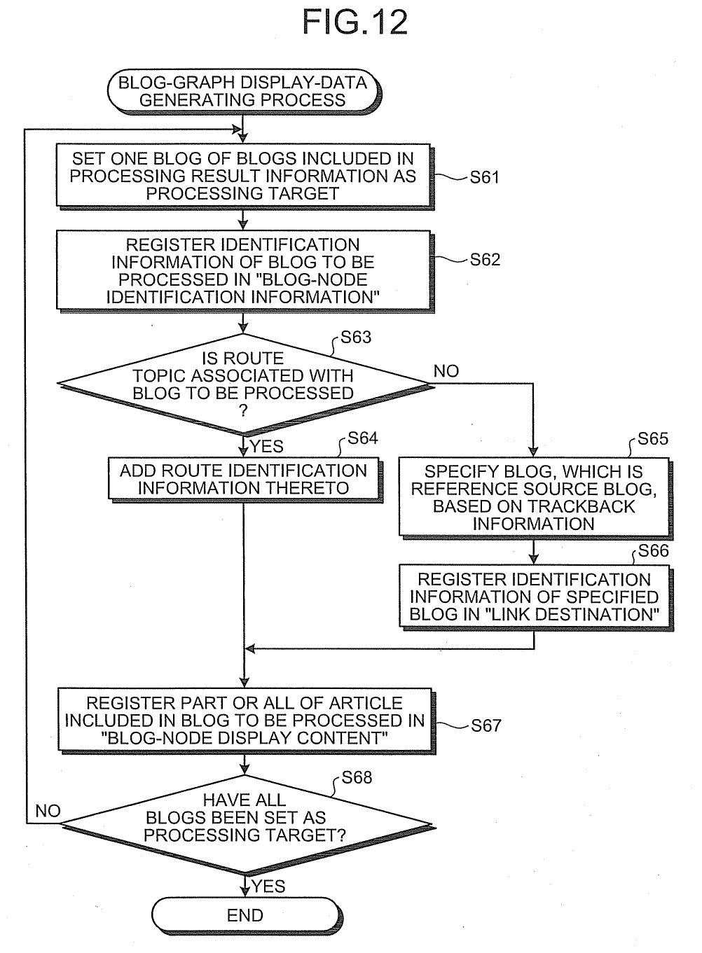

The blog-graph display data is explained with reference to FIGS. 11 and 12. The blog-graph display data is for displaying a relationship between the blogs acquired by the blog search unit 111 in a network blog graph based on the keyword. The display-data generating unit 113 executes a blog-graph display-data generating process described later (see FIG. 12), to generate the blog-graph display data for displaying the blog graph.

FIG. 11 is one example of the blog-graph display data generated by the display-data generating unit 113. As shown in FIG. 11, in the blog-graph display data, “blog-node identification information”, “blog-node display content”, and “link destination” are registered in association with each other.

The “blog-node identification information” is an item in which the identification information of the respective blogs included in the processing result information is registered. The “blog-node display content” is an item indicating the display content at the time of displaying the respective blogs included in the processing result information as a blog node BN described later, and a part or all of the article of the respective blogs are registered therein.

The “link destination” is an item indicating a connection between the blog nodes BN. Specifically, the “link destination” instructs to connect the blog node BN corresponding to the “blog-node identification information” and the blog node BN corresponding to the blog-node identification information registered in the “link destination” by a blog link BL described later.

In the blog-graph display data shown in FIG. 11, blog-node identification information “BLOG01” and “BLOG05” added with “V” are the route identification information indicating that it is a blog associated with the route topic, and added thereto at the time of registration of the blog-node identification information.

A blog-graph display-data generating process executed by the display-data generating unit 113 is explained below with reference to FIG. 12. FIG. 12 is a flowchart of the blog-graph display-data generating process procedure.

First, the display-data generating unit 113 sets one blog of the blogs included in the processing result information as a processing target by referring to the processing result information held in the RAM 15 or the storage unit 17 (step S61). The display-data generating unit 113 then registers the identification information of the blog in the “blog-node identification information” in the blog-graph display data (step S62).

Subsequently, the display-data generating unit 113 determines whether the rout topic is associated with the blog to be processed (step S63). When determining that the route topic is associated with the blog as the processing target (YES at step S63), the display-data generating unit 113 determines that the blog as the processing target is the route blog, and adds route identification information indicating that it is the route blog to the “blog-node identification information” thereto (step S64), to proceed to the processing at step S67.

On the other hand, when determining that the blog to be processed is not the rout topic at step S63 (NO at step S63), the display-data generating unit 113 specifies a blog, which becomes the reference source blog of the blog to be processed, based on the trackback information registered in association with the blog to be processed (step S65). The display-data generating unit 113 then registers the identification information of the blog specified at step S65 in the “link destination” in the blog-graph display data (step S66), to proceed to the processing at step S67.

At subsequent step S67, the display-data generating unit 113 registers a part or all of the article included in the blog to be processed in the “blog-node display content” in the blog-graph display data (step S67), and determines whether all the blogs included in the processing result information have been set as the processing target (step S68).

At step S68, when determining that there is an unprocessed blog (NO at step S68), the display-data generating unit 113 returns to the processing at step S61, to set the unprocessed blog as the processing target.

On the other hand, at step S68, when determining that all the blogs have been set as the processing target (YES at step S68), the display-data generating unit 113 finishes the process. The display-data generating unit 113 executes the process, to generate the blog-graph display data as shown in FIG. 11.

The display-data generating unit 113 generates display data including at least the topic-graph display data (the instance display data or the class display data) and the blog-graph display data, and transmits the display data to the client terminal 20 by using the communication processor 114.

The communication processor 114 accepts various pieces of information received via the communication unit 16, and transmits various pieces of information to an external device such as the client terminal 20 or the like via the communication unit 16.

The client terminal 20 is explained next. The client terminal 20 is, for example, a mobile phone, a personal digital assistant (PDA), or a personal computer (PC), and displays the display data transmitted from the relevant-information extracting server 10.

FIG. 13 is a block diagram of a hardware configuration of the client terminal 20. As shown in FIG. 13, the client terminal 20 includes a CPU 21, an operation unit 22, the display unit 23, a ROM 24, a RAM 25, a radio communication unit 26, and a storage unit 27, and respective units are connected with each other via a bus 28. Client terminals 40, 50, and 70 described later have the same hardware configuration.

The CPU 21 uses a predetermined area of the RAM 25 as a work area to execute various processing in cooperation with various control programs prestored in the ROM 24 or the storage unit 27, thereby generally controlling the operation of the respective units constituting the client terminal 20.

Further, the CPU 21 realizes function of respective functional units described later in cooperation with a predetermined program prestored in the ROM 24 or the storage unit 27. The operation of the respective functional units will be described later.

The operation unit 22 includes various buttons and input keys to receive information input from the user as an instruction signal to output the instruction signal to the CPU 21.

The display unit 23 includes a display device such as a liquid crystal display (LCD), and displays various pieces of information based on a display signal from the CPU 21. The display unit 23 can constitute a touch panel integrally with the operation unit 22.

The ROM 24 unrewritably stores programs and various pieces of setting information involved with the control of the client terminal 20.

The RAM 25 is a storage device such as an SDRAM, and functions as a work area of the CPU 21 to play a role as a buffer or the like. The RAM 25 also functions as a temporary storage device that temporarily stores the display data transmitted from the relevant-information extracting server 10.

The radio communication unit 26 is an interface that communicates with external equipment via the network N. Specifically, the radio communication unit 26 receives various pieces of information such as the display data transmitted from the external equipment, and outputs the information to the CPU 21. Further, the radio communication unit 26 transmits various pieces of information output from the CPU 21 to the external equipment.

The storage unit 27 includes a magnetically or optically recordable storage medium, and rewritably stores programs and various pieces of setting information involved with the control of the client terminal 20.

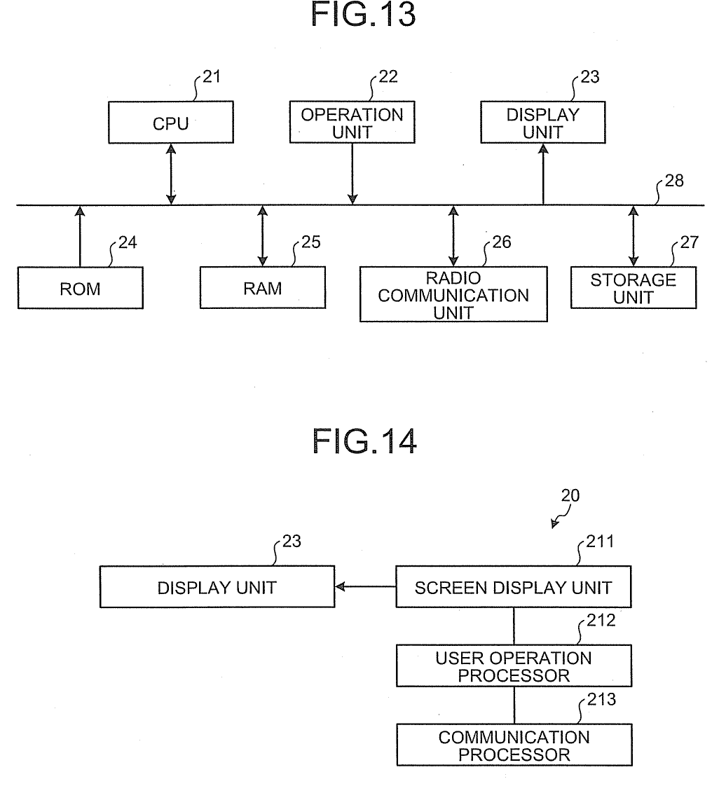

FIG. 14 is a block diagram of a functional configuration of the client terminal 20. As shown in FIG. 14, the client terminal 20 has a screen display unit 211, a user operation processor 212, and a communication processor 213.

The screen display unit 211 reads the display data temporarily stored in the RAM 25, and displays the display data in a display area of the display unit 23. Specifically, the screen display unit 211 displays the topic graph drawn based on the topic-graph display data and the blog graph drawn based on the blog-graph display data included in the display data in the display area of the display unit 23.

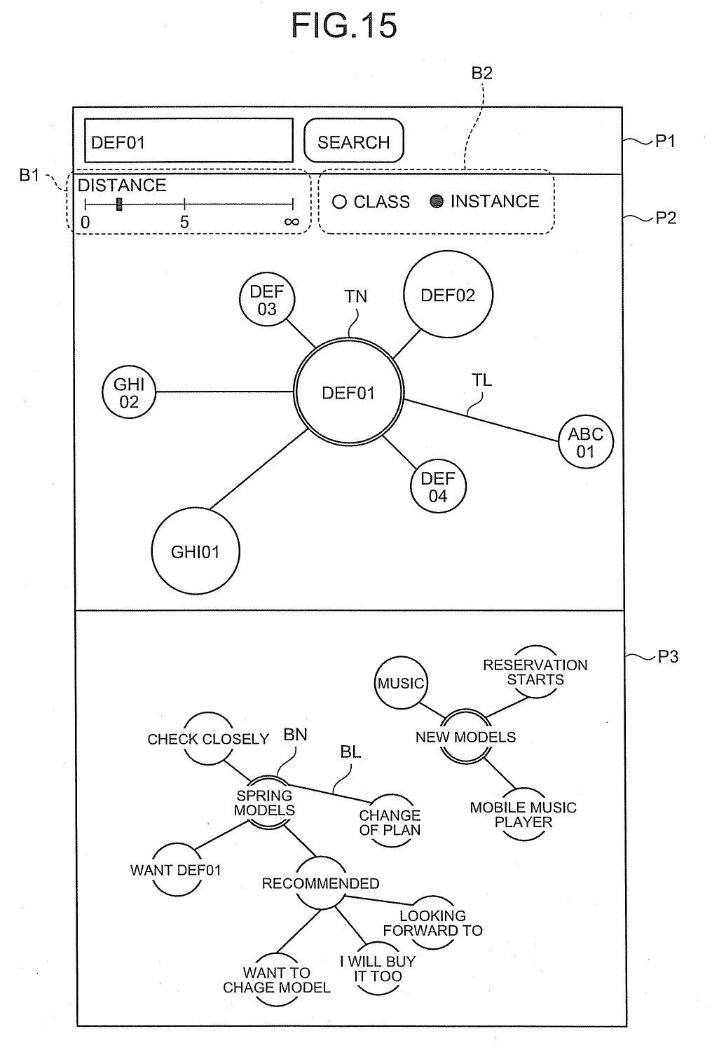

FIG. 15 is one example of the display data displayed in the display area of the display unit 23. As shown in FIG. 15, the display area has a configuration of three-pane display divided into three display areas P1 to P3, and information different from each other is displayed in each area.

In the display area P1, the keyword as a search target is input. The user can input a character string representing a specific trade name or the like via the operation unit 22. After the keyword is input, a “search button” is pressed. The communication processor 213 then transmits the input keyword as a search request to the relevant-information extracting server 10. In FIG. 15, an example in which “DEF01” is input as the keyword is shown.

In the display area P2, the topic graph of the display data transmitted from the relevant-information extracting server 10 is input. The topic graph shown in the display area P2 is displayed based on the topic graph display data (instance display data) in FIG. 7, under control of the screen display unit 211. The topic graph is explained below.

In the display area P2, topic node TN respectively corresponds to the “topic node name” of the instance display data. A topic node TN added with the route identification information corresponding to the route topic is expressed by a double circle, and a topic node TN corresponding to the association topic is expressed by a circle.

Further, each topic node TN is drawn according to a numerical value registered in the “node width” of the topic-graph display data, that is, in the size (diameter) corresponding to the degree of attention or the degree of interest of each topic (trade name). Therefore, the user can intuitively ascertain the relationship between the keyword (route topic) expressing the search target and relevant information (association topic) relating to the keyword.

The topic link TL connecting the topic nodes TN is drawn based on the “topic node name” of the instance display data and the topic node TN registered in the “link destination”. Further, the length of each topic link TL is determined based on a numerical value registered in the “link length” of the topic-graph display data. Therefore, the user can intuitively ascertain the relationship between the respective topics based on the length of the topic link TL.

In the display area P2, a slide bar B1 and a changeover button B2 are user operable interfaces provided (drawn) according to the control of the screen display unit 211. The slide bar B1 is for changing the display range of the topic to be displayed in the association topic graph, and changing the distance (the number of hops based on the class) on the topic ontology 172.

The changeover button B2 is for changing a display granularity of the topic graph, and is an interface for changing over the display of the topic graph based on the instance or based on the class. The operation involved with the operation of the slide bar B1 and the changeover button B2 will be described later. Further, the topic graph displayed based on the class display data will be described later.

In the display area P3, the blog graph of the display data transmitted from the relevant-information extracting server 10 is displayed. The blog graph shown in the display area P3 is drawn based on the blog graph display data in FIG. 11 under the control of the screen display unit 211. The blog graph is explained below.

In the display area P3, the blog node BN respectively correspond to the “blog-node identification information” in the blog-graph display data, and all or a part of the “blog-node display content” associated with the “blog-node identification information” is displayed therein. The blog node BN added with the route identification information is expressed by a double circle, and other blog nodes BN are expressed by a circle.

The blog link BL connecting between the blog nodes BN is drawn based on the “blog-node identification information” in the blog-graph display data and the blog-node identification information registered in the “link destination”. Further, the length of each blog link BL is drawn based on a numerical value registered in the “link length” of the blog-graph display data. Therefore, the user can intuitively ascertain the trackback relationship between the respective blogs, which are information sources of the route topic corresponding to the keyword and the association topic associated with the keyword.

The display format of the display data is not limited to the example. For example, a mode in which the topic graph is displayed in an upper rank and the blog graph is displayed in a lower rank is shown. However, on the contrary, the mode can be such that the blog graph is displayed in the upper rank and the topic graph is displayed in the lower rank. Further, the topic graph and the blog graph can be displayed side by side. It is preferable to display those graphs according to the shape or the like of the display area of the display unit 23.

Returning to FIG. 14, the user operation processor 212 receives instruction information input from the user via the operation unit 22, and outputs the instruction information to the screen display unit 211 or the communication processor 213. For example, when the touch panel is formed by the display unit 13 and the operation unit 12, the user operation processor 212 outputs the instruction information instructed from the user via the display screen to the screen display unit 211 or the communication processor 213.

The communication processor 213 accepts various pieces of information received via the radio communication unit 26, and transmits various pieces of information to the external device such as the relevant-information extracting server 10 via the radio communication unit 26. Upon reception of the display data transmitted from the relevant-information extracting server 10, the communication processor 213 temporarily stores the display data in the RAM 25.

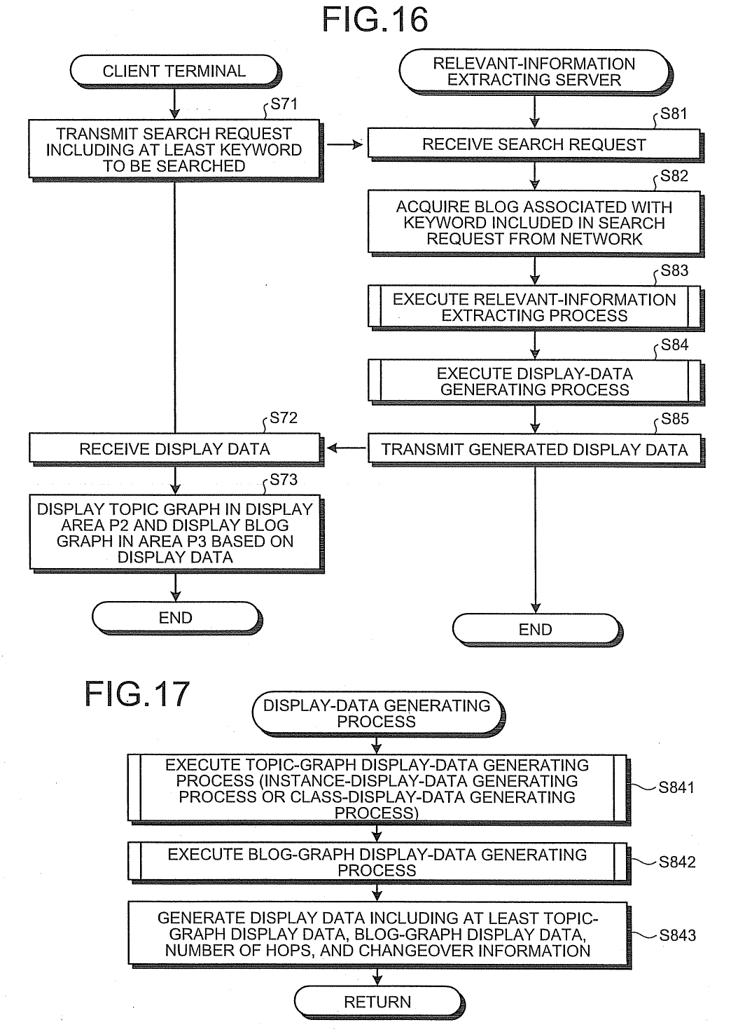

The overall operation of the first embodiment is explained next. FIG. 16 is a flowchart of a relevant-information display process procedure executed by the relevant-information extracting server 10 and the client terminal 20. In FIG. 16, steps S71 to S73 are processes executed by the client terminal 20, and steps S81 to S85 are processes executed by the relevant-information extracting server 10.

First, on the client terminal 20 side, a keyword to be searched is input in the display area P1, and when the “search button” is pressed, the communication processor 213 transmits a search request including the keyword to the relevant-information extracting server 10 via the radio communication unit 26 (step S71).

On the other hand, when the relevant-information extracting server 10 receives the search request transmitted from the client terminal 20 (step S81), the blog search unit 111 acquires a blog including the keyword in a text from the blog site on the network N based on the keyword included in the search request (step S82).

Subsequently, the relevant-information extracting unit 112 executes the relevant-information extracting process based on the blog acquired at step S82 (step S83). The relevant-information extracting process at step S83 is the same as the relevant-information extracting process explained with reference to FIG. 7, and therefore explanations thereof will not be repeated.

The display-data generating unit 113 then executes the display-data generating process based on processing result information held in the RAM 15 or the storage unit 17 obtained by the process at step S83 (step S84). The display-data generating process at step S84 is explained below, with reference to FIG. 17.

FIG. 17 is a flowchart of the display-data generating process procedure at step S84. First, the display-data generating unit 113 executes the topic-graph display-data generating process (step S841). In the topic-graph display-data generating process, either one of the instance-display-data generating process explained with reference to FIG. 8 or the class-display-data generating process explained with reference to FIG. 10 is executed. In the first embodiment, it is assumed that it is preset to execute the instance-display-data generating process.

The display-data generating unit 113 then executes the blog-graph display-data generating process (step S842). Because the blog-graph display-data generating process at step S842 is the same as the blog-graph display-data generating process explained with reference to FIG. 12, explanations thereof will not be repeated.

Subsequently, the display-data generating unit 113 generates display data including at least the number of hops used in the relevant-information extracting process and information indicating which of the instance-display-data generating process and the class-display-data generating process is executed at step S841 (changeover information), together with the topic-graph display data and the blog-graph display data generated at steps S841 and S942 (step S843), to proceed to the process at step S85 in FIG. 16.

Returning to FIG. 16, the communication processor 114 transmits the display data generated by the process at step S84 to the client terminal 20 (step S85). Thus, the process on the relevant-information extracting server 10 side finishes.

On the other hand, when the client terminal 20 receives the display data transmitted from the relevant-information extracting server 10, the communication processor 213 temporarily stores the display data in the RAM 15 (step S72). Subsequently, the screen display unit 211 displays the topic graph in the display area P2 of the display unit 23 based on the topic-graph display data included in the display data, and displays the blog graph in the display area P3 based on the blog-graph display data included in the display data (step S73), to finish the process on the client terminal 20 side.

The display result of the process at step S73 is as shown in FIG. 15. The position of a bar of the slide bar B1 in the display area P2 is displayed based on the number of hops included in the display data. The changeover button in the display area P2 is displayed based on the information indicated by the changeover information included in the display data (instance or class), and indicates whether the topic graph is based on the instance or the class by a black circle.

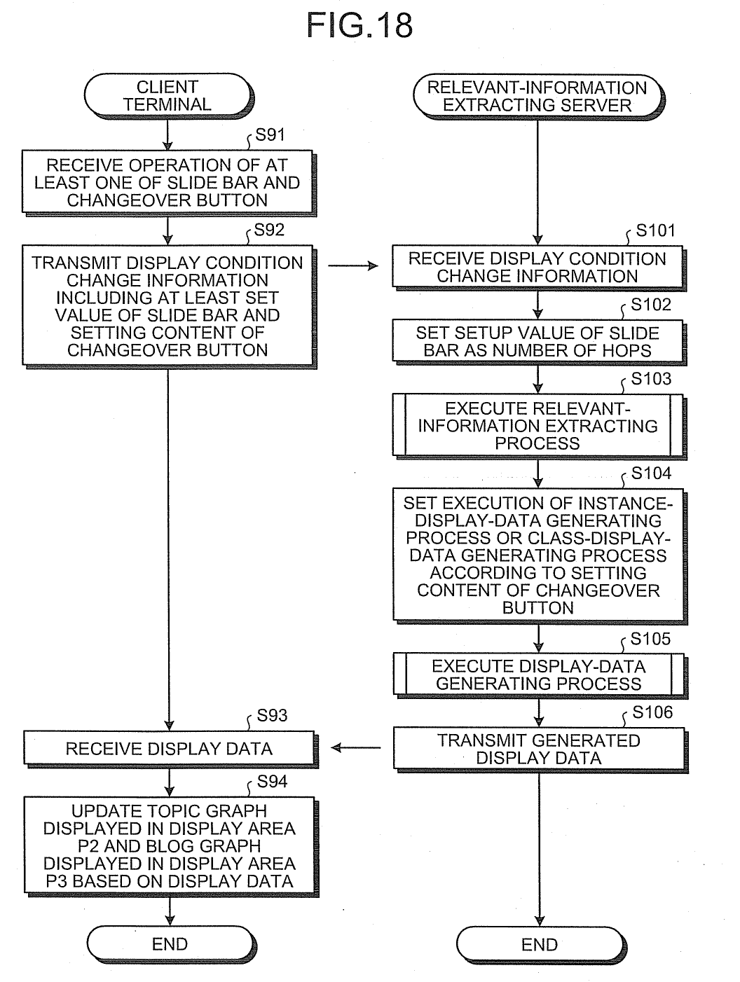

The operation when at least one of the slide bar B1 and the changeover button B2 displayed in the display area P2 is operated is explained next. FIG. 18 is a flowchart of the display-data update process procedure to be executed when the slide bar button B1 or the changeover button B2 is pressed. As a presupposition of the process, it is assumed that the display data shown in FIG. 15 is displayed on the display unit 23 of the client terminal 20.

First, in the client terminal 20, upon operation of at least one of the slide bar B1 and the changeover button B2 by the user, the user operation processor 212 receives the operation content (step S91). The user operation processor 212 then transmits display condition change information including at least a setup value of the currently set slide bar B1 and the setting content of the changeover button B2 to the relevant-information extracting server 10 by using the communication processor 213 (step S92).

On the other hand, in the relevant-information extracting server 10, upon reception of the display condition change information transmitted from the client terminal 20, the communication processor 114 outputs the display condition change information to the display-data generating unit 113 (step S101).

Subsequently, the display-data generating unit 113 sets the setup value of the slide bar B1 included in the display condition change information as the number of hops at the time of extracting the association topic from the topic ontology 172 (step S102), and executes the relevant-information extracting process based on the number of hops (step S103). Because the relevant-information extracting server 10 at step S103 is the same as that explained with reference to FIG. 5, explanations thereof will not be repeated.

Next, the display-data generating unit 113 sets a processing content to be executed in the display-data generating process at step S105 (the instance-display-data generating process or the class-display-data generating process) according to the setting content of the changeover button B2 included in the display condition change information (step S104). The display-data generating unit 113 then executes the display-data generating process based on the processing result information generated in the relevant-information extracting process at step S103 (step S105). The process at step S105 is the same as the display-data generating process at step S84 explained with reference to FIG. 17, and therefore explanations thereof will not be repeated. However, it is assumed that in the topic-graph display-data generating process, the processing content (the instance-display-data generating process or the class-display-data generating process) set at step S104 is executed.

The communication processor 114 then transmits the display data generated in the display-data generating process at step S105 to the client terminal 20 (step S106), to finish the processing on the relevant-information extracting server 10 side.

On the other hand, in the client terminal 20, upon reception of the display data transmitted from the relevant-information extracting server 10, the communication processor 213 temporarily stores the display data in the RAM 25 (step S93). The screen display unit 211 then updates the topic graph displayed in the display area P2 of the display unit 23 based on the topic-graph display data included in the display data, and updates the blog graph displayed in the display area P3 based on the blog-graph display data included in the display data (step S94), to finish the processing on the client terminal 20 side.

In the processing, in the display-data generating process at step S105, the blog-graph display-data generating process is also executed. However, the present invention is not limited to this mode, and such a mode that only the topic-graph display-data generating process is executed and the blog-graph display-data generating process is not executed can be used. In this case, the display data includes only the topic-graph display data. Therefore, the screen display unit 211 in the client terminal 20 updates the display of the display area P2 of the display unit 23.

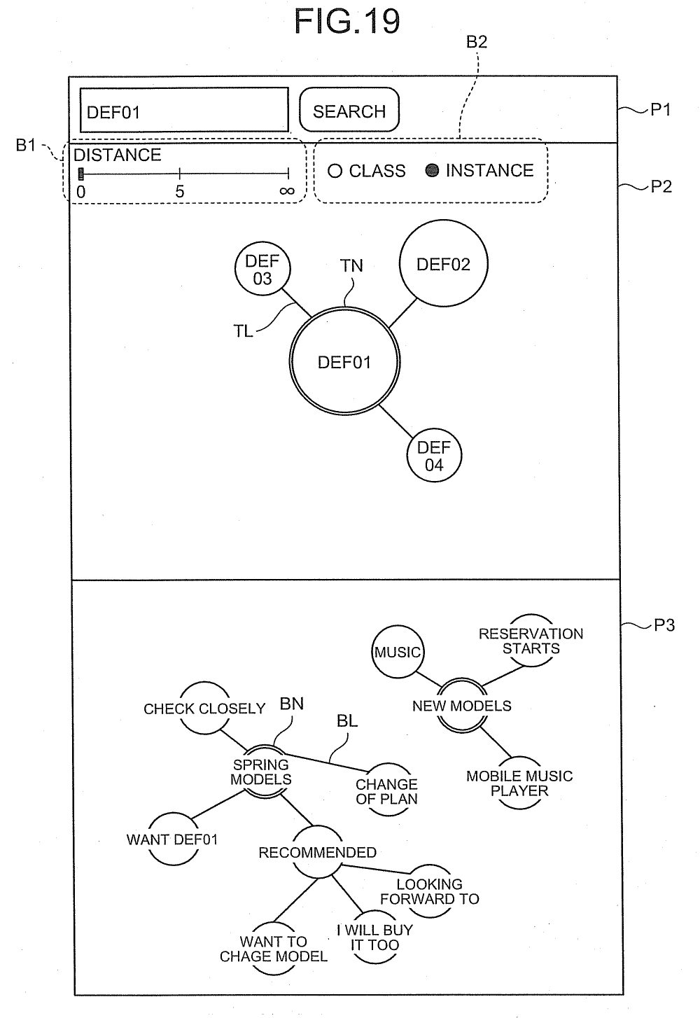

FIG. 19 is a display example when the setup value of the slide bar B1 is changed from “2” shown in FIG. 15 to “0”. When the setup value of the slide bar B1 is “0”, the number of hops used in the relevant-information extracting process becomes “0”. Therefore, only the association topics “DEF02”, “DEF03”, and “DEF04” are extracted from class C6 (genre name DEF) to which the instance I2 corresponding to the keyword “DEF01” belongs. Therefore, as the topic node TN displayed in the display area P2, those obtained by excluding “ABC01”, “GHI01”, and “GHI02” from the topic nodes TN shown in FIG. 15 are displayed. When the number of hops is “0”, the distance on the topic ontology 172 becomes equidistant, and therefore all the topic links TL are displayed in the same length.

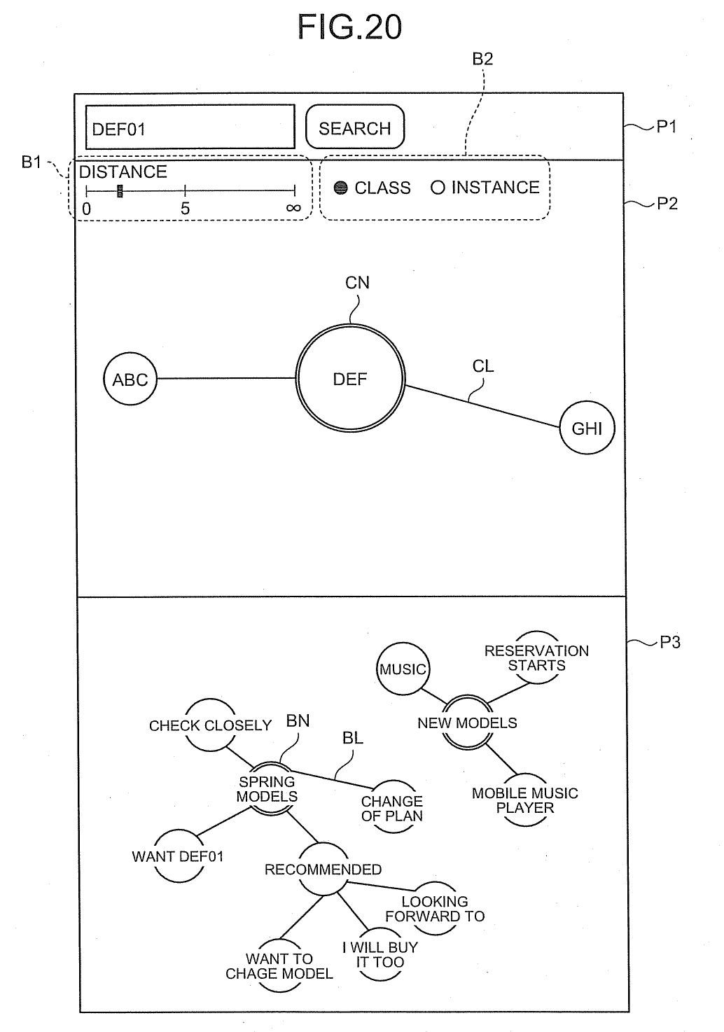

FIG. 20 is a display example when the setting content “instance” of the changeover button B2 shown in FIG. 15 is changed over to the “class”. When the changeover button B2 is changed over to the “class”, because the processing executed in the topic-graph display-data generating process is changed over from the instance-display-data generating process to the class-display-data generating process, the class display data is included in the display data. Accordingly, the topic graph in which the relationship between the keyword and the association topic associated with the keyword is expressed by the relationship between the classes is displayed in the display area P2.

In the display area P2, the class node CN respectively corresponds to the “class node name” in the class display data is displayed. A class node CN corresponding to the route class is expressed by a double circle, and class nodes CN corresponding to other classes are expressed by a circle. The size (diameter) of each class node CN is drawn based on a numerical value registered in the “node width” in the class display data.

The class link CL connecting between the class nodes CN is drawn based on the name of the class node CN registered in the “link destination” in the class display data. The length of each class link CL is drawn based on a numerical value registered in the “link length” in the class display data. Therefore, the user can confirm the relationship between the route topic, which is a search target, and the association topic associated with the search target based on a category name, which is a broader concept of these topics.

According to the first embodiment, because a keyword to be searched and a topic associated with the keyword are extracted from a character string included in a web document acquired for the keyword based on the topic ontology, information of an object to be detected can be efficiently extracted. Further, the relationship between the keyword and the topic associated with the keyword is visualized in the topic graph expressed by the size of the topic node and the length of the topic link, and a reference relationship between the web documents as information sources can be visualized by the blog graph expressed by the blog node and the blog link. Accordingly, the relationship between the keyword to be searched and the association topic associated with the keyword can be expressed efficiently and multilaterally.

Further, because a depth of the search for the topic associated with the keyword can be changed by the operation of the slide bar B1, the relationship between the keyword and the topic associated with the keyword can be ascertained from a multilateral point of view, whereby the convenience for the user improves. Furthermore, because the relationship between the keyword and the topic associated with the keyword can be visualized in the topic graph based on the instance or the class by the operation of the changeover button B2, the relationship between the keyword and the topic associated with the keyword can be ascertained from a multilateral point of view, whereby the convenience for the user improves.

In the first embodiment, the display data generated by the relevant-information extracting server 10 is displayed by the client terminal 20. However, the present invention is not limited to this mode, and such a mode can be used that the display data is displayed on the relevant-information extracting server 10 side. A mode in which the display data is displayed on the relevant-information extracting server 10 side is explained below.

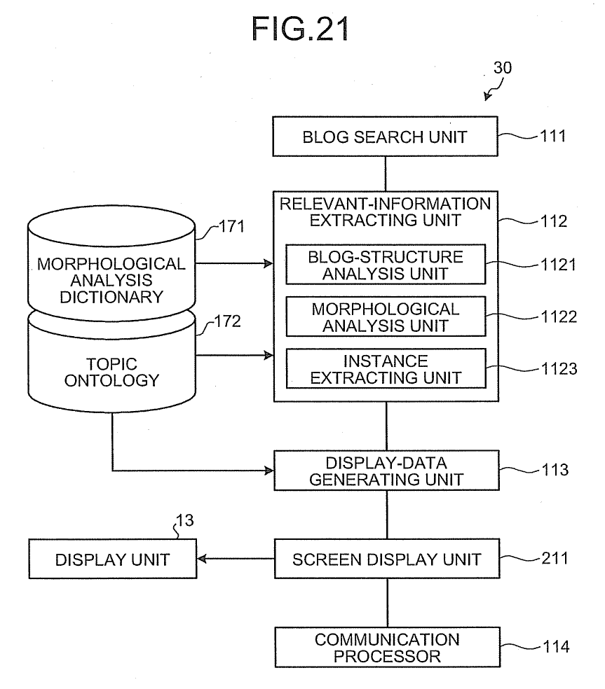

FIG. 21 depicts a functional configuration of a relevant-information extracting server 30, which is another mode of the relevant-information extracting server 10 according to the first embodiment. As shown in FIG. 21, the relevant-information extracting server 30 includes the screen display unit 211 in addition to the configuration shown in FIG. 4, thereby enabling to display the display data on the relevant-information extracting server 30 side. Therefore, a series of processing from generation to display of the display data can be performed in a stand-alone manner. A screen to be displayed on the display unit 13 by the screen display unit 211 has a configuration of the three-pane display as in the display example shown in FIG. 15.

Further, such a mode that the processing result information and the display data are generated only on the client terminal side can be used. A mode in which the client terminal side generates the processing result information and the display data is explained below.

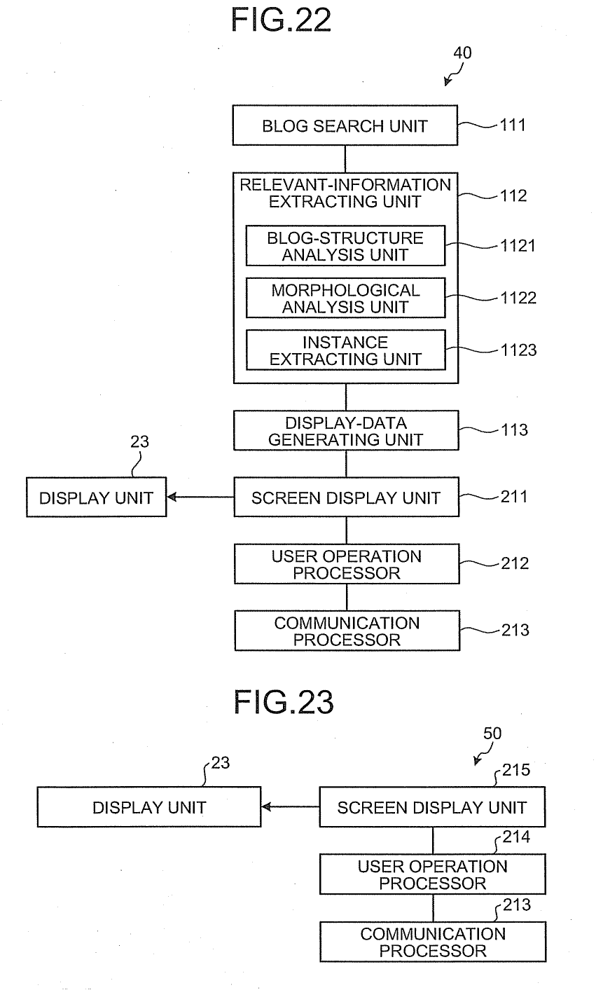

FIG. 22 depicts a functional configuration of a client terminal 40, which is another mode of the client terminal 20 according to the first embodiment. As shown in FIG. 22, the client terminal 40 includes the blog search unit 111, the relevant-information extracting unit 112, and the display-data generating unit 113 in addition to the configuration shown in FIG. 14. The morphological analysis dictionary 171 and the topic ontology 172 can be incorporated in the client terminal 40, or the morphological analysis dictionary 171 and the topic ontology 172 stored in the external device such as the relevant-information extracting server 10 can be used via the communication unit 16. Thus, because the client terminal 40 side includes a functional unit involved with the generation of the processing result information and the display data, the series of processing from generation to display of the display data can be performed on the client terminal 40 side.

A configuration in which a predetermined operation can be performed with respect to the topic node TN in the topic graph is explained below as a second embodiment of the present invention. Like reference numerals are designated to like functional parts as those in the first embodiment, and explanations thereof will not be repeated.

FIG. 23 is a block diagram of a functional configuration of a client terminal 50 according to the second embodiment. As shown in FIG. 23, the client terminal 50 includes the communication processor 213, a user operation processor 214, and a screen display unit 215.

The user operation processor 214 has the same function as that of the user operation processor 212, to receive the instruction information for selecting a specific topic node TN in the topic graph input via the operation unit 22, and transmit node-detail request information including at least the topic node name (for example, W42T) of the selected topic node TN to the relevant-information extracting server 10 via the communication processor 213.

The screen display unit 215 has the same function as that of the screen display unit 211, to display on the display unit 23 information of the selected topic node TN based on node detail information described later transmitted from the relevant-information extracting server 10, as a response to the node-detail request information.

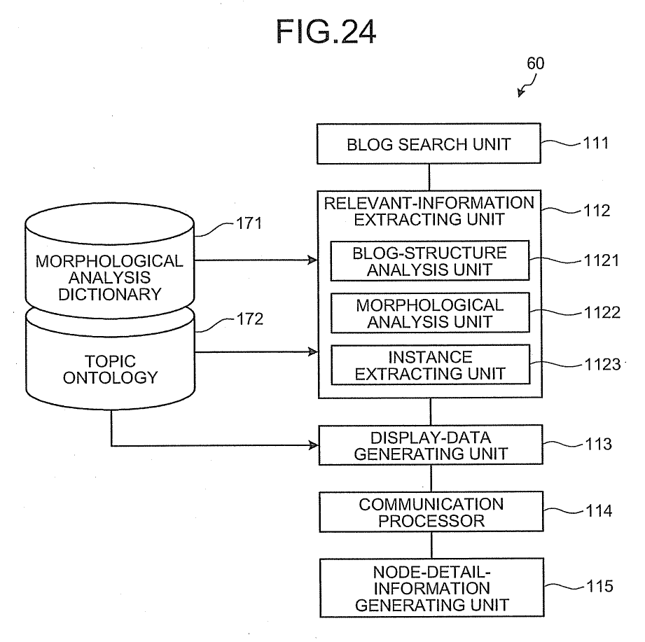

FIG. 24 is block diagram of a functional configuration of a relevant-information extracting server 60 according to the second embodiment. As shown in FIG. 24, the relevant-information extracting server 60 includes the blog search unit 111, the relevant-information extracting unit 112, the display-data generating unit 113, the communication processor 114, and a node-detail-information generating unit 115.

The node-detail-information generating unit 115 generates information relating to the topic node name instructed by the node-detail request information from the processing result information based on the node-detail request information transmitted from the client terminal 50 and transmits the information as the node detail information to the client terminal 20 by the communication processor 114.

Specifically, the node-detail-information generating unit 115 refers to the processing result information held in the RAM 15 or the storage unit 17 to specify the blog associated with the topic corresponding to the topic node name instructed by the node-detail request information. Further, the node-detail-information generating unit 115 calculates the total number of the specified blogs, and also calculates the total number of trackbacks imparted to the blogs and the total number of comments, thereby generating the node detail information including at least the calculation results, the identification information of the blog specified from the processing result information, and the topic node name instructed by the node-detail request information.

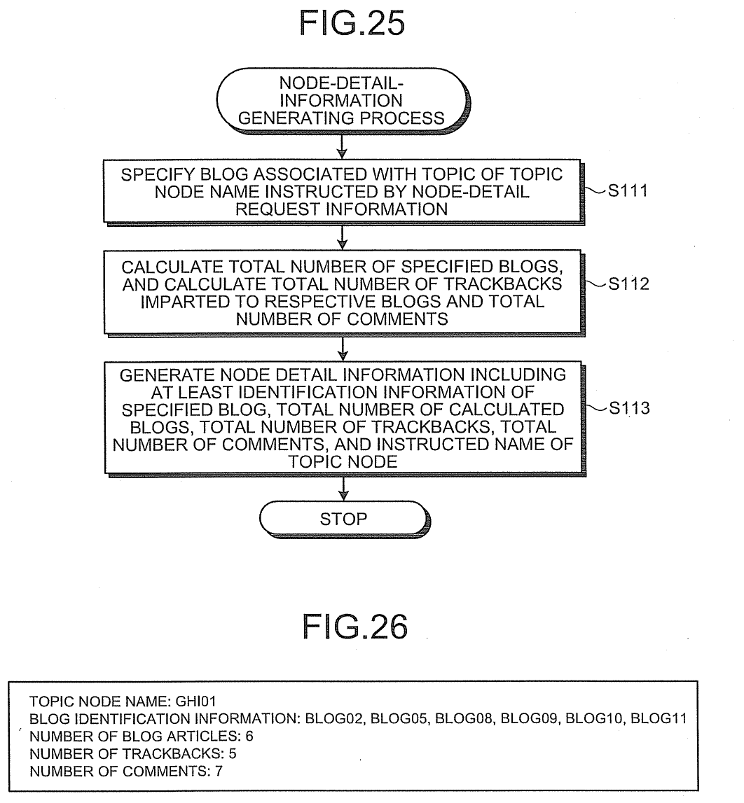

FIG. 25 is a flowchart of a node-detail-information generating process procedure performed by the node-detail-information generating unit 115. The node-detail-information generating unit 115 refers to the processing result information to specify the blog associated with the topic with the topic node name instructed by the node-detail request information (step S111).

The node-detail-information generating unit 115 then calculates the total number of the blogs specified at step S111, and also calculates the total number of trackbacks imparted to these blogs and the total number of comments (step S112). The node-detail-information generating unit 115 generates the node detail information (see FIG. 26) including at least the identification information of the blogs specified at step S111, the respective values calculated at step S112, and the name of the topic node TN instructed by the node-detail request information (step S113), to finish the process.

FIG. 26 is one example of the node detail information generated by the node-detail-information generating process. As shown in FIG. 26, the node detail information includes the topic node name instructed by the node-detail request information, the identification information of the specified blog, the number of blog articles indicating the total number of blogs, the number of trackbacks indicating the total number of trackbacks, and the number of comments indicating the total number of comments. In the example in FIG. 26, a result when “GHI01” is instructed as the node-detail request information is shown, where the topic node name is “GHI01”, the blog identification information is “BLOG02, BLOG05, BLOG08, BLOG09, BLOG10, BLOG11”, the number of blog articles is “6”, the number of trackbacks is “5”, and the number of comments is “7”.

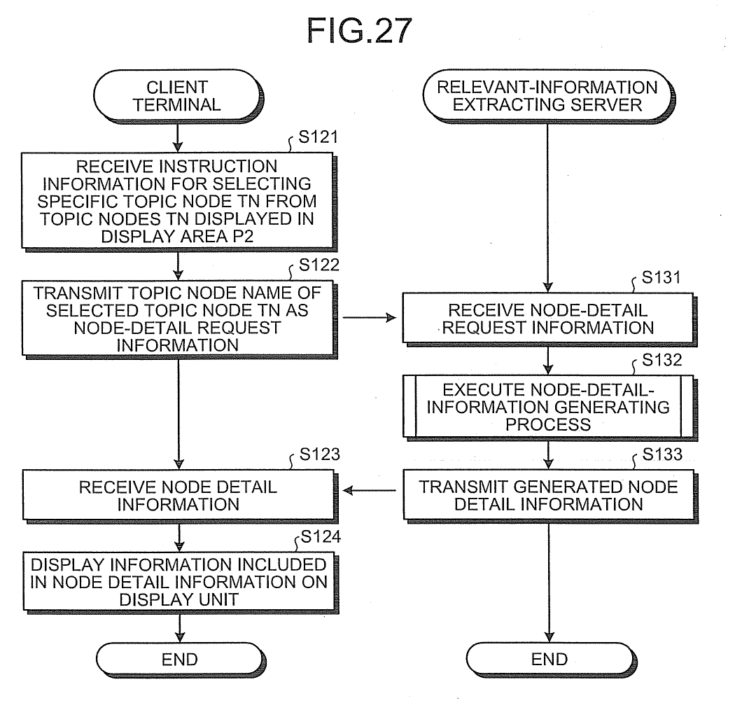

An overall operation when a specific topic node TN is selected from the topic graph displayed in the display area P2 is explained next with reference to FIG. 27. FIG. 27 is a flowchart of a node-detail-information display process procedure executed by the client terminal 50 and the relevant-information extracting server 60. It is assumed that the display data shown in FIG. 15 is displayed on the display unit 23 of the client terminal 50 as a presupposition of the process.

First, in the client terminal 50, when the operation unit 22 is operated by the user to select the specific topic node TN from the topic nodes TN displayed in the display area P2, the user operation processor 212 receives the operation content (step S121). The user operation processor 212 transmits the selected topic node name as the node-detail request information to the relevant-information extracting server 60 via the communication processor 213 (step S122).

On the other hand, in the relevant-information extracting server 60, upon reception of the node-detail request information transmitted from the client terminal 50, the communication processor 114 outputs the node-detail request information to the node-detail-information generating unit 115 (step S131).

Subsequently, the node-detail-information generating unit 115 refers to the processing result information to execute a node-detail-information generating process (step S132). Because the node-detail-information generating process at step S132 is the same as the node-detail-information generating process explained in FIG. 25, explanations thereof will not be repeated.

The communication processor 114 then transmits the node detail information generated by the node-detail-information generating process at step S132 to the client terminal 50, to finish the process on the relevant-information extracting server 60 side.

On the other hand, in the client terminal 50, upon reception of the node detail information transmitted from the relevant-information extracting server 60, the communication processor 213 temporarily stores the node detail information in the RAM 25 (step S123). The screen display unit 215 displays the information included in the node detail information on the display unit 23 based on the node detail information (step S124), to finish the process on the client terminal 50 side.

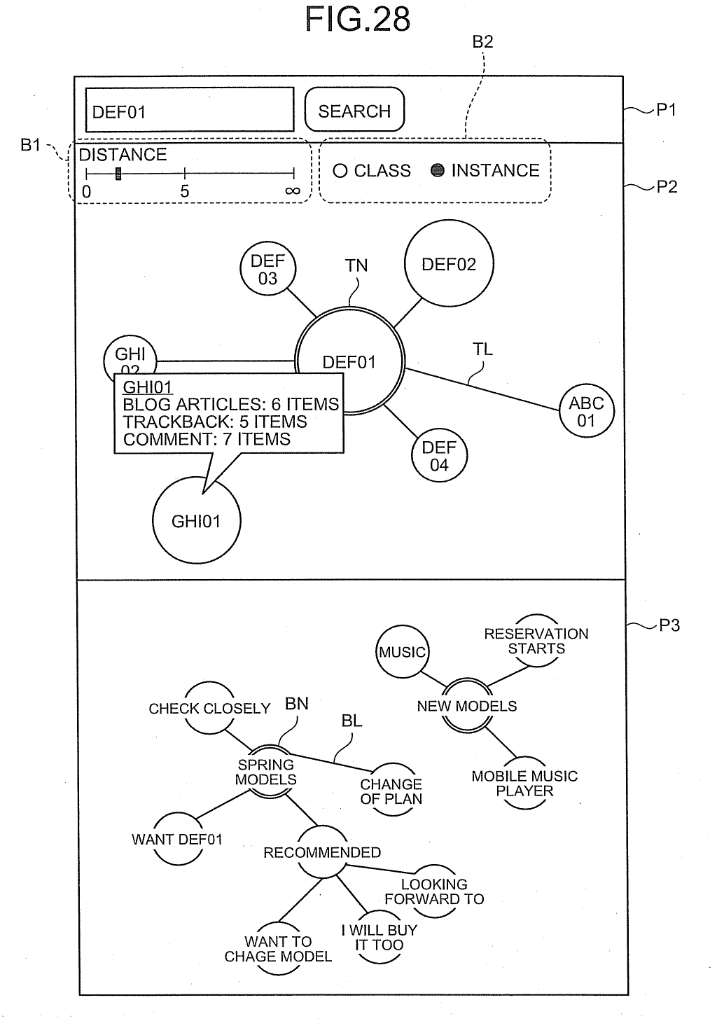

FIG. 28 is one example of the node detail information displayed in the display area P2 of the display unit 23 by the process at step S124. In FIG. 28, a display result when the topic node TN having the name of “DEF01” is selected by the user is shown, where the topic node name, the number of blog articles, the number of trackbacks, and the number of comments are displayed in a state associated with the topic node TN of “DEF01”.

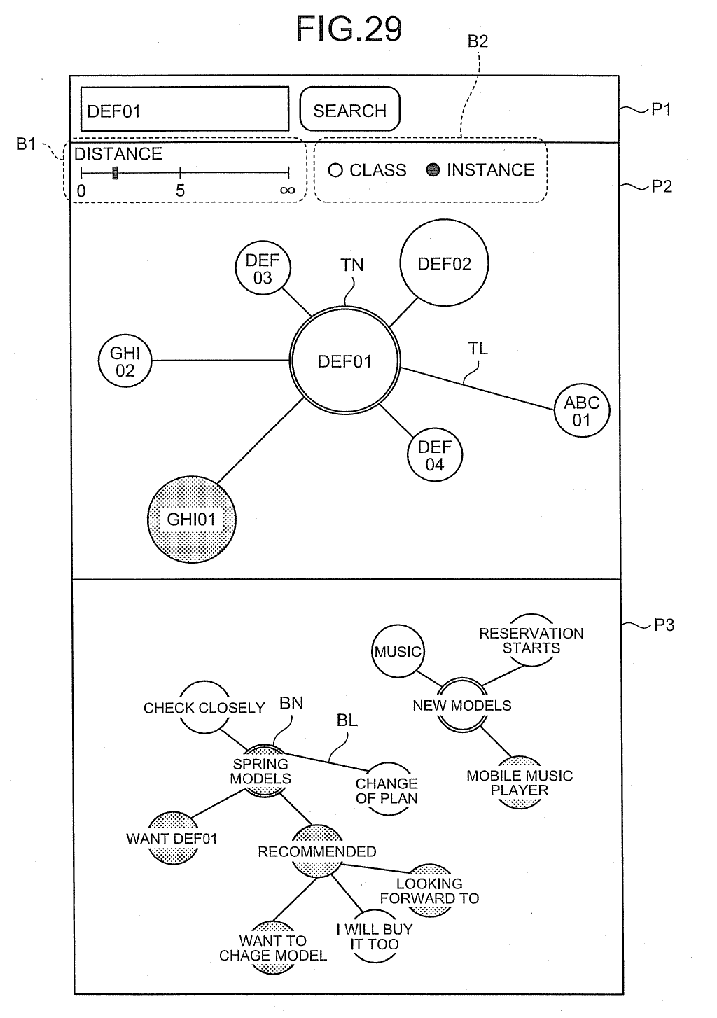

FIG. 29 depicts another mode of the node detail information displayed on the display unit 23, and depicts the node detail information displayed in the display area P3. In FIG. 29, the blog node BN corresponding to the identification information of the blog included in the node detail information is highlighted, thereby identifiably displaying the blog node BN associated with the topic node TN with the selected topic node name “DEF01”.

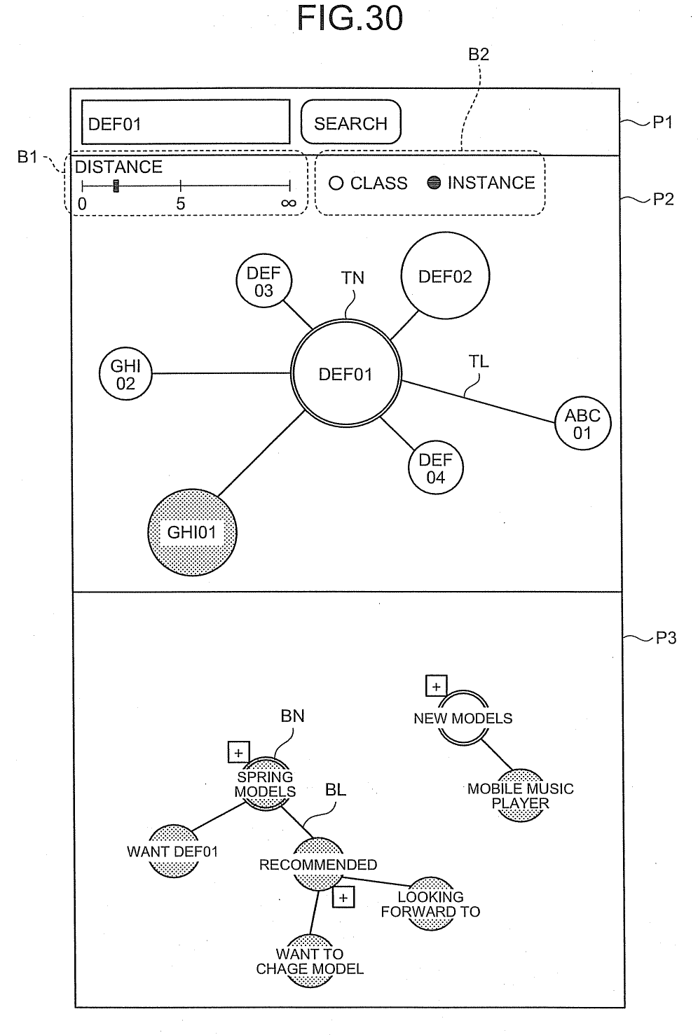

As shown in FIG. 30, it can be controlled such that only the blog node BN corresponding to the identification information included in the node detail information (hereinafter, “associated blog node BN”) is displayed in the display area P3. The screen display unit 215 displays the blog node BN with display being controlled corresponding to a press signal of “+” sign detected by the user operation processor 214, and controls to change over display and non-display every time the “+” sign is pressed. It is desired to display the “+” sign near a parent node (host node) of the blog node BN whose display is controlled.

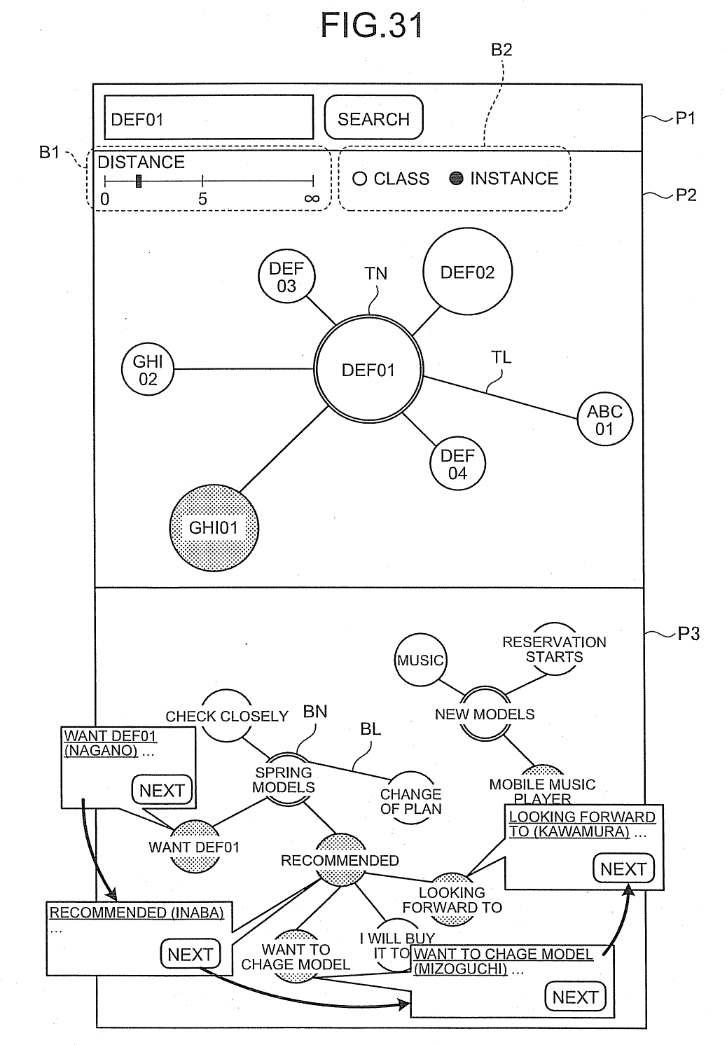

Further, the information of the associated blog node BN can be displayed with respect to the associated blog node. Specifically, the screen display unit 215 controls, as shown in FIG. 31, such that a part or all of the blog article corresponding to the associated blog node BN is displayed in association with the highlighted associated blog node BN. The content of the article to be displayed is read from a “blog node display content” in the blog-graph display data.

At this time, a part or all the content of the article can be sequentially displayed for each associated blog node BN. Specifically, the display can be controlled so that the blog article corresponding to the associated blog node BN is sequentially displayed in order of arrow, every time “next” button displayed in each associated blog node BN is pressed. The display order can be preset, or the blog article can be displayed sequentially corresponding to the update date and time included in the identification information of the respective blogs. An interface capable of specifying the display order by the user can be separately provided, to display the blog article in an order specified by the user.

As described above, according to the second embodiment, the specific topic node TN is selected from the topic graph displayed on the display unit 23, whereby the information of the topic node TN can be displayed. Accordingly, analysis of the respective topics can be efficiently performed.

A configuration in which a predetermined operation can be performed with respect to the blog node BN in the blog graph is explained as a third embodiment of the present invention. Like reference numerals are designated to like functional parts as those in the first and second embodiments, and explanations thereof will not be repeated.

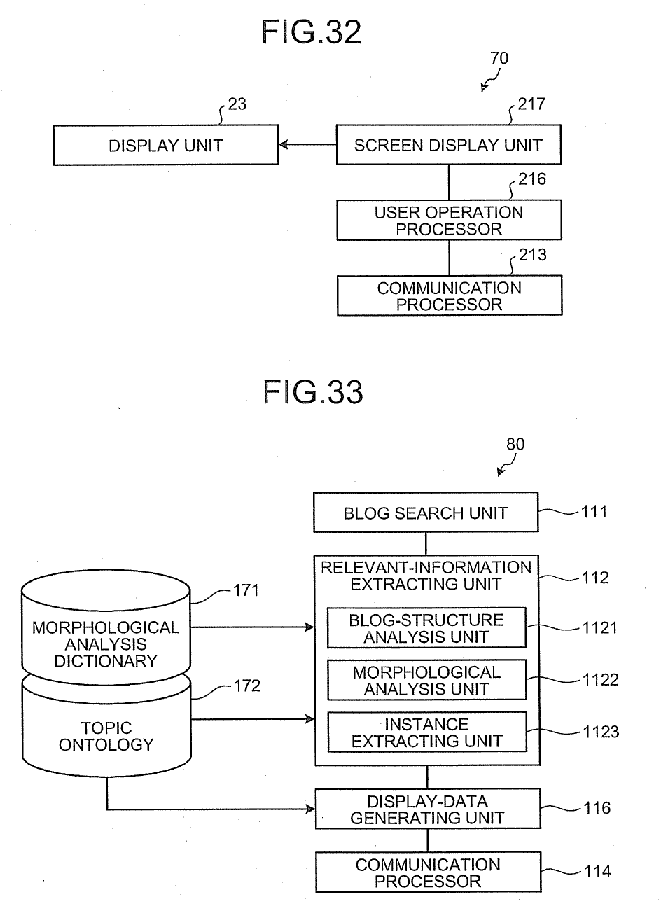

FIG. 32 is a block diagram of a functional configuration of a client terminal 70 according to the third embodiment. As shown in FIG. 32, the client terminal 70 includes the communication processor 213, a user operation processor 216, and a screen display unit 217.

The user operation processor 216 has the same function as that of the user operation processor 212, to receive the instruction information for selecting a specific blog node BN in the topic graph input via the operation unit 22, and transmit narrowing request information including at least the blog node identification information (for example, BLOG04) of the selected blog node BN to a relevant-information extracting server 80 by using the communication processor 213.

The screen display unit 217 has a similar function to that of the screen display unit 211, to update the topic graph displayed in the display area P2 of the display unit 23 based on the instance display data transmitted from the relevant-information extracting server 80 as a response to the narrowing request information.

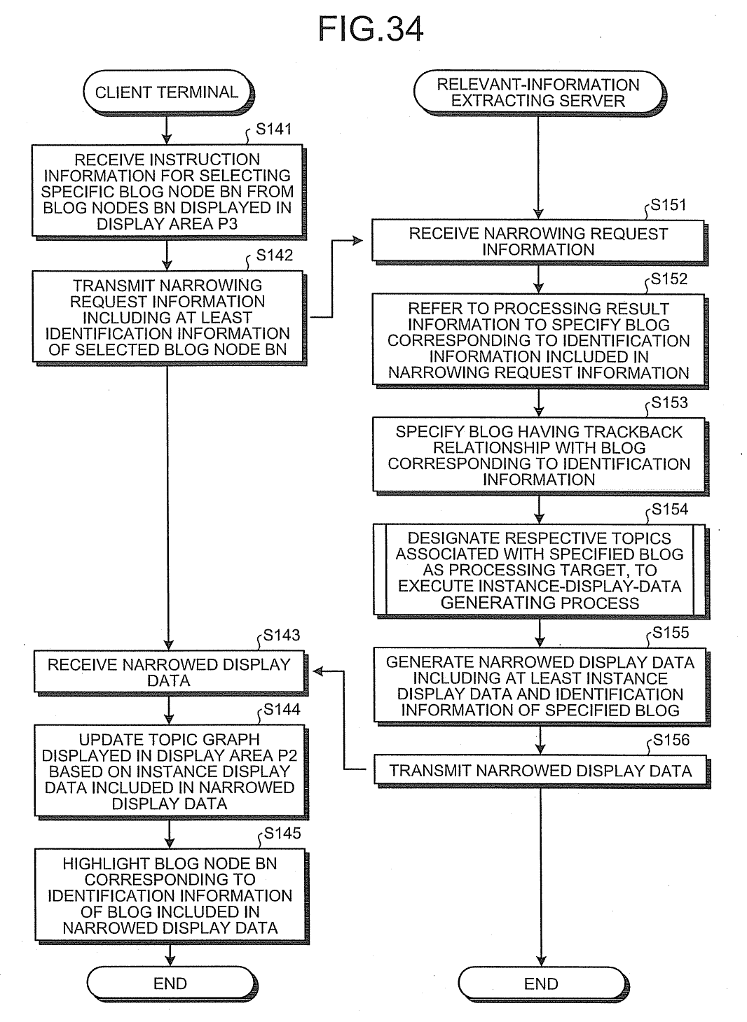

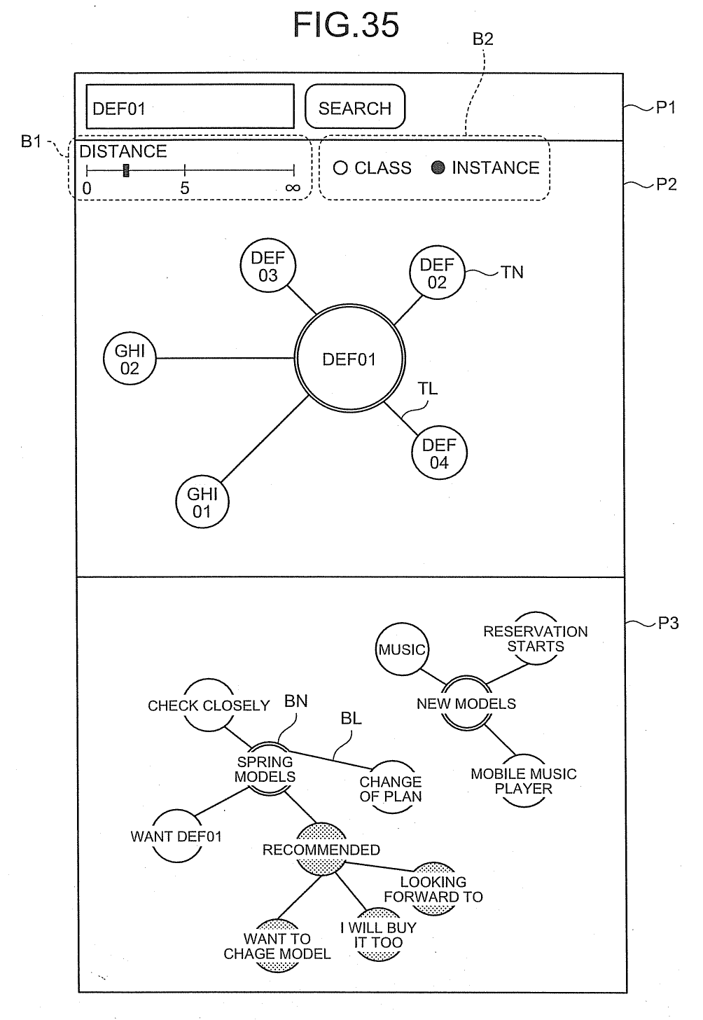

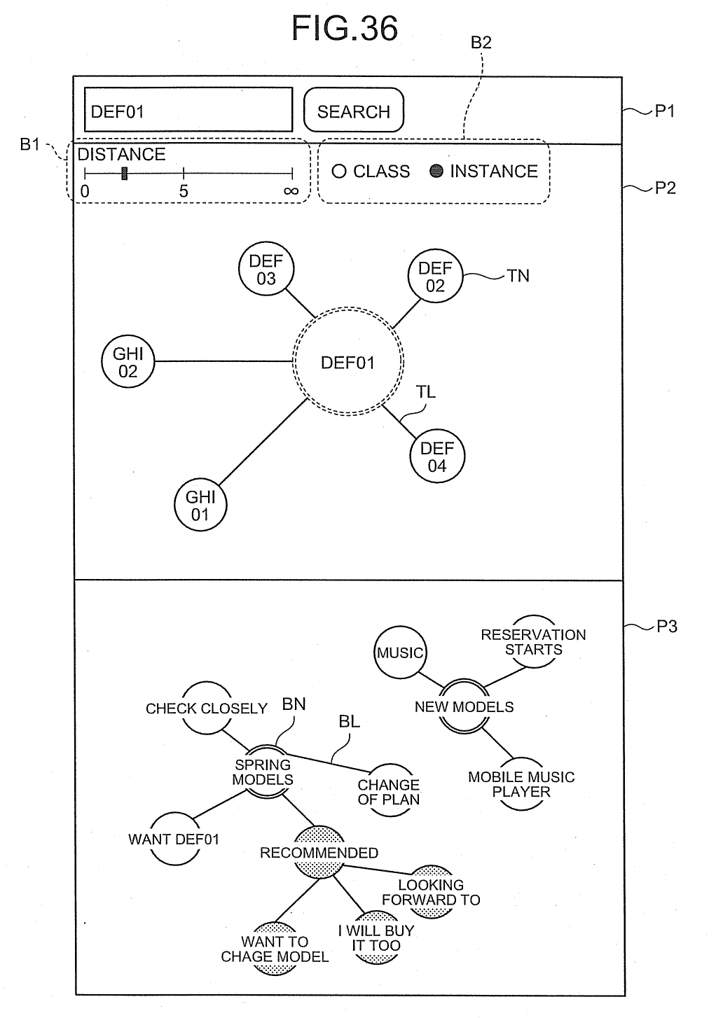

FIG. 33 is a block diagram of a functional configuration of the relevant-information extracting server 80 according to the third embodiment. As shown in FIG. 33, the relevant-information extracting server 80 includes the blog search unit 111, the relevant-information extracting unit 112, the communication processor 114, and a display-data generating unit 116.

The display-data generating unit 116 has the same function as that of the display-data generating unit 113. Upon reception of the narrowing request information transmitted from the client terminal 70 via the communication processor 114, the display-data generating unit 116 specifies a blog corresponding to the name of the blog node BN included in the narrowing request information and other blog having the trackback relationship with the blog from the processing result information held in the RAM 15 or the storage unit 17. The display-data generating unit 116 executes the instance-display-data generating process with respect to the topic associated with the respective blogs specified from the processing result information, to thereby generate the instance display data, and transmits the instance display data to the client terminal 70 via the communication processor 114.

An overall operation when the specified blog node BN is selected from the blog graph displayed in the display area P3 is explained next with reference to FIG. 34. FIG. 34 is a flowchart of a narrowed-down display process procedure executed by the client terminal 70 and the relevant-information extracting server 80. It is assumed that the display data shown in FIG. 15 is displayed on the display unit 23 of the client terminal 70 as a presupposition of the process.

First, in the client terminal 70, when a specific blog node BN is selected from the blog nodes BN displayed in the display area P3 via the operation unit 22, the user operation processor 216 receives the operation content (step S141). The user operation processor 216 then transmits the narrowing request information including at least the identification information of the selected blog node BN to the relevant-information extracting server 80 via the communication processor 213 (step S142).

Meanwhile, in the relevant-information extracting server 80, upon reception of the narrowing request information transmitted from the client terminal 70, the communication processor 114 outputs the narrowing request information to the display-data generating unit 116 (step S151).

Subsequently, the display-data generating unit 116 refers to the processing result information to specify the blog corresponding to the identification information of the blog node BN included in the narrowing request information (step S152). The display-data generating unit 116 then specifies the blog associated with the trackback information, in which the specified blog is used as a reference source, that is, the blog having the trackback relationship with the blog specified at step S152 (step S153).

Next, the display-data generating unit 116 designates the respective topics associated with the blog specified at steps S152 and S153 as a candidate to be processed, to execute the instance-display-data generating process (step S154). Because the instance-display-data generating process at step S154 is the same as the instance-display-data generating process explained with reference to FIG. 8, explanations thereof will not be repeated.

The display-data generating unit 116 then generates narrowed display data including at least the instance display data generated by the process at step S154 and the identification information of the blog specified at steps S152 and S153 (step S155). The communication processor 114 transmits the narrowed display data generated at step S155 to the client terminal 70, to finish the process on the relevant-information extracting server 80 side.

On the other hand, in the client terminal 70, upon reception of the narrowed display data transmitted from the relevant-information extracting server 80, the communication processor 213 temporarily stores the narrowed display data in the RAM 25 (step S143). The screen display unit 217 updates the topic graph displayed in the display area P2 of the display unit 23 based on the instance display data included in the narrowed display data (step S144). The screen display unit 217 highlights the blog node BN corresponding to the identification information of the blog included in the narrowed display data, among the blog nodes BN displayed in the display area P3 (step S145), to finish the process on the client terminal 70 side.

FIG. 35 depicts a display result at steps S144 and S145. FIG. 35 depicts a display result when the blog node BN expressed as “RECOMMENDED” is selected in the blog graph shown in FIG. 15. The topic graph displayed in the display area P2 is the one generated based on the blog corresponding to four blog nodes BN highlighted in the display area P3.

As described above, according to the third embodiment, a specific blog node BN is selected from the blog graph displayed on the display unit 23, whereby the blog involved with generation of the topic graph can be narrowed down. Accordingly, because the user can visualize the relationship between the keyword to be searched and the topic associated with the keyword in the area of the selected blog, the relationship between the keyword and the topic associated with the keyword can be ascertained from the multilateral point of view.

Depending on the blog node BN to be selected, the topic node TN corresponding to the keyword can disappear. In this case, because the relationship between the keyword and the association topic becomes unclear, as shown in FIG. 36, it is desired to indicate the topic node TN corresponding to the keyword by broken line or the like, thereby specifying the presence thereof.

While three embodiments of the present invention have been explained above, the present invention is not limited thereto, and various changes, substitutions, and additions are possible within the scope of the invention.

For example, a program used in the processing of the above embodiments can be provided as a computer readable recording medium. Any storage format can be used, so long as a computer readable storage medium that can store a program such as a magnetic disk, an optical disk (CD-ROM, CD-R, DVD, and the like), a magneto-optical disk (MO and the like), and a semiconductor memory is used as the storage medium.

The program used in the processing of the above embodiments can be stored in a computer connected to a network such as the Internet, and the program can be provided via the network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information display apparatus comprising:
a display unit;
a first accepting unit that accepts a keyword to be searched;
an acquiring unit that acquires one or a plurality of web documents associated with the keyword from a network;
a dividing unit that divides a character string included in each of the web document into one or a plurality of words;
a first storage unit that stores an ontology in which an instance expressing each of the words is defined in association with a class to which the instance belongs, and a relation between the instances is defined by a distance between the classes;
an instance extracting unit that extracts an instance matching each of the words divided by the dividing unit from the ontology;
a second storage unit that stores the web documents, each extracted instance in association with the web document including the word matching the instance, and stores a reference relationship indicating a connection between the web documents;
a first display-condition determining unit that determines a size of a topic node at a time of displaying each instance stored in the second storage unit as a topic node according to number of web documents associated with each instance, and determines a length of a topic link connecting a topic node of the instance expressing a word of the keyword to a topic node of an instance other than the instance according to a distance between classes to which each instance defined in the ontology belongs;
a second display-condition determining unit that determines a connection of web links, which connects the web nodes, at a time of displaying each web document stored in the second storage unit as a web node, based on the reference relationship of the web documents;
a first display control unit that displays a first graph in which a relationship between instances stored in the second storage unit is expressed by the topic node and the topic link, in a first display area of the display unit, based on a size of the topic node and the length of the topic link determined by the first display-condition determining unit; and
a second display control unit that displays a second graph in which the relationship between web documents stored in the second storage unit is expressed by the web node and the web link, in a second display area of the display unit, based on the connection of the web links determined by the second display-condition determining unit.

2. The information display apparatus according to claim 1, further comprising a structure analysis unit that extracts an acquisition source, from which another web document having a relationship with the web document acquired by the acquiring unit is acquired, from the web document, thereby acquiring the other web document from the acquisition source by the acquiring unit.

3. The information display apparatus according to claim 1, wherein the instance extracting unit extracts an instance matching each word divided by the dividing unit from instances in each class present within a range of a predetermined number of hops from a base class, designating a class to which an instance expressing the keyword belongs as the base class.

4. The information display apparatus according to claim 3, further comprising a second accepting unit that accepts designation of the number of hops, wherein
the instance extracting unit extracts the instance matching each word divided by the dividing unit from instances in each class present within the range of the number of hops accepted by the second accepting unit from the base class.

5. The information display apparatus according to claim 1, further comprising
a third display-condition determining unit that determines a size of a class node at the time of displaying a class to which each instance stored in the second storage unit belongs as the class node, according to number of instances for each class to which each instance belongs, and determines a length of a class link connecting a class node to which the instance expressing the word of the keyword belongs to a class node of a class other than the class according to a distance between classes defined in the ontology, wherein
the first display control unit displays a third graph in which a relationship between classes, to which each instance stored in the second storage unit belongs, is expressed by the class node and the class link, in the first display area of the display unit based on the size of the class node and the length of the class link determined by the third display-condition determining unit.

6. The information display apparatus according to claim 5, further comprising
a third accepting unit that accepts instruction information instructing changeover of the graph displayed in the first display area, wherein
the first display control unit displays one of the first graph and the third graph in the first display area of the display unit according to an instruction content accepted by the third accepting unit.

7. The information display apparatus according to claim 1, further comprising:
a fourth accepting unit that accepts selection of a specific topic node among topic nodes displayed in the first display area;
a relevant-information extracting unit that specifies an instance corresponding to the specific topic node to extract relevant information of the web document associated with the instance from the second storage unit; and
a third display control unit that displays the relevant information extracted by the relevant-information extracting unit in at least one of the first display area and the second display area.

8. The information display apparatus according to claim 1, further comprising:
a fifth accepting unit that accepts selection of a specific web node among the web nodes displayed in the second display area; and
a narrowing unit that specifies a web document corresponding to the specific web node and a web document having a reference relationship with the web document from the second storage unit, and extracts an instance associated with each of the web documents, wherein
the first display-condition determining unit determines the size of the topic node at the time of displaying each of the instances as the topic node, and the length of the topic link connecting the topic node of the instance expressing the word of the keyword to a topic node other than the topic node within a range of each instance extracted by the narrowing unit.

9. An information display method executed by an information display apparatus including a display unit, comprising:
accepting a keyword to be searched;
acquiring one or a plurality of web documents associated with the keyword from a network;
dividing a character string included in each of the web document into one or a plurality of words;
extracting an instance matching each of the words divided at the dividing from an ontology in which the instance expressing each of the words is defined in association with a class to which the instance belongs, and a relation between the instances is defined by a distance between the classes;
storing including storing each instance extracted from the ontology in association with the web document including the word matching the instance, and storing a reference relationship indicating a connection between the web documents;
first determining of determining a size of a topic node at a time of displaying each instance stored at the storing as a topic node according to number of web documents associated with each instance;
second determining of determining a length of a topic link connecting a topic node of the instance expressing a word of the keyword to a topic node of an instance other than the instance according to a distance between classes to which each instance defined in the ontology belongs;
third determining of determining a connection of web links, which connects the web nodes, at a time of displaying each web document stored at the storing as a web node, based on the reference relationship of the web documents;
first displaying of displaying a first graph in which a relationship between the instances stored at the storing is expressed by the topic node and the topic link, in a first display area of the display unit, based on a size of the topic node and the length of the topic link; and
second displaying of displaying a second graph in which the relationship between the web documents stored at the storing is expressed by the web node and the web link, in a second display area of the display unit, based on the connection of the web links.

10. A computer program product having a computer readable medium including programmed instructions executable by a computer provided with a display unit, wherein the instructions, when executed by the computer, cause the computer to perform:
accepting a keyword to be searched;
acquiring one or a plurality of web documents associated with the keyword from a network;
dividing a character string included in each of the web document into one or a plurality of words;
extracting an instance matching each of the words divided at the dividing from an ontology in which the instance expressing each of the words is defined in association with a class to which the instance belongs, and a relation between the instances is defined by a distance between the classes;
storing including storing each instance extracted at the extracting in association with the web document including the word matching the instance, and storing a reference relationship indicating a connection between the web documents;
first determining of determining a size of a topic node at a time of displaying each instance stored at the storing as a topic node according to number of web documents associated with each instance;
second determining of determining a length of a topic link connecting a topic node of the instance expressing a word of the keyword to a topic node of an instance other than the instance according to a distance between classes to which each instance defined in the ontology belongs;
third determining of determining a connection of web links, which connects the web nodes, at a time of displaying each web document stored at the storing as a web node, based on the reference relationship of the web documents;
first displaying of displaying a first graph in which a relationship between instances stored at the storing is expressed by the topic node and the topic link, in a first display area of the display unit, based on a size of the topic node and the length of the topic link; and
second displaying of displaying a second graph in which the relationship between web documents stored at the storing is expressed by the web node and the web link, in a second display area of the display unit, based on the connection of the web links.
